(19) United States
(12) Patent Application Publication
(10) Pub. No.: US 2009/0082967 A1
(43) Pub. Date: Mar. 26, 2009

(54) Route length calculation apparatus, route length calculation method, route length calculation program, automotive air conditioner, and controller for apparatus mounted in mobile object

(75) Inventors: Kousuke Hara, Tokyo (JP); Yoshiaki Sakakura, Yokohama-city (JP); Hirotoshi Iwasaki, Kawasaki-city (JP); Hiroshi Takeda, Nagoya-city (JP); Yasufumi Kojima, Gifu-city (JP); Tetsuya Hara, Okazaki-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/283,906

(22) Filed: Sep. 16, 2008

(30) Foreign Application Priority Data
Sep. 21, 2007 (JP) 2007-245953

(51) Int. Cl. G01C 21/00

(52) U.S. Cl. 701/225

(57) ABSTRACT

A route length calculation apparatus comprises: a location detection unit for acquiring current location of a mobile object; an event detection unit for detecting the occurrence of an applicable event; a route history information storage unit for storing, upon occurrence of a first event, past route information containing at least the point of occurrence of the first event; and a distance calculation unit for calculating, when occurrence of a second event is detected by the event detection unit, the shortest route length between the point of occurrence of the second event acquired by the location detection unit and the point of occurrence of the first event along a route that the mobile object has traveled before.

The Applicant claims the right to priority based on Japanese Patent Application JP 2007-245953, filed on Sep. 21, 2007, and the entire content of JP 2007-245953 is hereby incorporated by reference.

### FIELD OF THE INVENTION

The present invention relates to a route length calculation apparatus, a route length calculation method, a route length calculation program, an automotive air conditioner, and a controller for an apparatus mounted in a mobile object, and more particularly to a route length calculation apparatus, a route length calculation method, a route length calculation program for calculating the shortest route length from a specific point of interest up to a destination, and an automotive air conditioner which optimizes air conditioner setting with respect to a specific location by using such an apparatus, method, and program.

### BACKGROUND OF THE INVENTION

In recent years, various navigation systems for route searching have been developed. Navigation systems are widely used not only as in-vehicle systems but also as systems mounted in portable terminals. In these navigation systems, it is important to accurately find the shortest route from a starting point to a destination. To this end, various methods for route searching have been developed and used. One of the representative methods used for route searching is Dijkstra's algorithm. In Dijkstra's algorithm, for example, each intersection is represented by a node, and the road from one intersection to the next is represented by a link having length information. The route from the starting point to the destination is calculated by connecting the links and nodes alternately and, from the routes thus calculated, the route having the shortest length is selected.

For example, in the route searching apparatus disclosed in Japanese Unexamined Patent Publication No. H06-174485, the length of the link from one node to the next is corrected by the width and attribute of the road, the time required to travel along the link is obtained based on the corrected link length, and the required time thus obtained is displayed.

On the other hand, depending on the service provided to the user, it may be required to select the route only from the roads that the user have traveled before. Similarly, it may be required to calculate the distance between a plurality of points based only on the roads that the user have traveled before. However, since the prior art route searching apparatus and method simply obtains the shortest route from the starting point to the destination, as in the above route searching apparatus, a road that the user has never traveled before may be included in the route.

### SUMMARY OF THE INVENTION

It is an object of the present invention to provide a route length calculation apparatus and method that calculates the shortest route length between a plurality of points based only on the routes that the user has traveled before.

It is another object of the present invention to provide an automotive air conditioner which automatically optimizes air conditioner setting for a specific situation by using a probabilistic model, wherein when generating the probabilistic model, the shortest route length between a plurality of points where a specific setting operation has been performed is obtained based only on the routes that the vehicle has traveled before, and the range where the specific situation is expected to occur is determined based on the thus obtained shortest route length.

According to one aspect of the present invention, there is provided a route length calculation apparatus for calculating the shortest route length between a plurality of points of occurrence of events relating to a mobile object. The route length calculation apparatus includes: a location detection unit for acquiring current location of the mobile object; an event detection unit for detecting the occurrence of an applicable event; a route history information storage unit for storing, upon occurrence of a first event, past route information containing at least the point of occurrence of the first event; and a distance calculation unit for calculating, when occurrence of a second event is detected by the event detection unit, the shortest route length between the point of occurrence of the second event acquired by the location detection unit and the point of occurrence of the first event along a route that the mobile object has traveled before.

With the above configuration, the route length calculation apparatus can obtain the shortest route length between the point of occurrence of the first event and the point of occurrence of the second event along a route that the mobile object has traveled before at least once.

Preferably, when the occurrence of the first event is detected, the route history information storage unit stores as the past route information a past route which is a route traveled by the mobile object when the mobile object passed the point of occurrence of the first event, and when it is determined that the point of occurrence of the second event is located on the past route, the distance calculation unit calculates the shortest route length along the past route. With this configuration, the route length calculation apparatus can obtain the shortest route length between the point of occurrence of the first event and the point of occurrence of the second event along the route traveled in the past.

Preferably, the route length calculation apparatus further includes: a road information acquiring unit for acquiring road information; and a route determining unit for acquiring from the location detection unit the locations of a plurality of points on the past route within a predetermined range containing the point of occurrence of the first event, and for obtaining the past route information by matching the locations of the plurality of points with the road information acquired by the road information acquiring unit.

Preferably, the past route information includes a first moving direction indicating the moving direction of the mobile object along the past route, and the location detection unit acquires a second moving direction indicating the moving direction of the mobile object at the point of occurrence of the second event, wherein the distance calculation unit determines that the point of occurrence of the second event is located on the past route only when the second moving direction coincides with the first moving direction. With this configuration, the route length calculation apparatus can obtain the shortest route length by also considering the moving direction of the mobile object at the time of event occurrence. Accordingly, the route length calculation apparatus can evaluate the route length between the event occurrence points by discriminating between the case where the plurality of events occurred due to reasons that differ depending on the moving direction and the case where the plurality of events occurred due to reasons independent of the moving direction.

Preferably, the past route information includes a traveled distance from a starting point to each of the plurality of points on the past route or a relative distance from the point of occurrence of the first event, and the distance calculation unit calculates the shortest route length by referring to the traveled distance or the relative distance. With this configuration, since the route length calculation apparatus need not reexamine the route between the event occurrence points, the amount of computation required for the calculation of the route length can be reduced.

Preferably, the route length calculation apparatus further includes a road information acquiring unit for acquiring road information; and a route determining unit for acquiring from the location detection unit the locations of a plurality of points on a current route which is a route traveled by the mobile object when the mobile object passed the point of occurrence of the second event when the occurrence of the second event is detected by the event detection unit, and for obtaining current route information indicating the current route by matching the locations of the plurality of points with the road information acquired by the road information acquiring unit. Preferably, in this case, when it is determined from the current road information, in conjunction with the point of occurrence of the first event stored in the route history information storage unit, that the point of occurrence of the first event is located on the current route, the distance calculation unit calculates the shortest route length along the current route. With this configuration, the route length calculation apparatus can obtain the shortest route length between the point of occurrence of the first event and the point of occurrence of the second event along the route traveled at the time of occurrence of the second event.

Preferably, the location detection unit acquires a moving direction of the mobile object at the time of detection of the location of the mobile object, and the past route information includes a first moving direction indicating the moving direction of the mobile object at the point of occurrence of the first event, while the current route information includes a second moving direction indicating the moving direction of the mobile object along the current route, wherein the distance calculation unit determines that the point of occurrence of the first event is located on the current route only when the first moving direction coincides with the second moving direction. With this configuration, the route length calculation apparatus can obtain the shortest route length by also considering the moving direction of the mobile object at the time of event occurrence. Accordingly, the route length calculation apparatus can evaluate the route length between the event occurrence points by discriminating between the case where the plurality of events occurred due to reasons that differ depending on the moving direction and the case where the plurality of events occurred due to reasons independent of the moving direction.

Preferably, the current route information includes a traveled distance from a starting point to each of the plurality of points on the current route or a relative distance from the point of occurrence of the second event, and the distance calculation unit calculates the shortest route length by referring to the traveled distance or the relative distance. With this configuration, since the route length calculation apparatus need not reexamine the route between the event occurrence points, the amount of computation required for the calculation of the route length can be reduced.

Preferably, the route length calculation apparatus further includes: a road information acquiring unit for acquiring road information; and a route determining unit for acquiring from the location detection unit the locations of a plurality of points on a current route which is a route traveled by the mobile object when the mobile object has passed the point of occurrence of the second event when the occurrence of the second event is detected by the event detection unit, and for obtaining current route information indicating the current route by matching the locations of the plurality of points with the road information acquired by the road information acquiring unit. Preferably, in this case, the route history information storage unit stores the point of occurrence of the first event as the past route information together with a specific point that the mobile object passed before or after passing the point of occurrence of the first event, and when it is determined from the current road information, in conjunction with the past route information stored in the route history information storage unit, that the specific point is located on the current route, the distance calculation unit calculates the shortest route length along the current route or the past route. With this configuration, even in cases where the route that the mobile object traveled at the time of occurrence of the first event and the route that the mobile object traveled at the time of occurrence of the second event separate from each other or merge together along the way, the route length calculation apparatus can obtain the shortest route length between the point of occurrence of the first event and the point of occurrence of the second event along the route traveled at the time of occurrence of the first event or the route traveled at the time of occurrence of the second event.

Preferably, the location detection unit acquires a moving direction of the mobile object at the time of detection of the location of the mobile object, and the past route information includes a first moving direction indicating the moving direction of the mobile object at the specific point, while the current route information includes a second moving direction indicating the moving direction of the mobile object along the current route, wherein the distance calculation unit determines that the specific point is located on the current route only when the first moving direction coincides with the second moving direction. With this configuration, the route length calculation apparatus can obtain the shortest route length by also considering the moving direction of the mobile object at the time of event occurrence. Accordingly, the route length calculation apparatus can evaluate the route length between the event occurrence points by discriminating between the case where the plurality of events occurred due to reasons that differ depending on the moving direction and the case where the plurality of events occurred due to reasons independent of the moving direction.

Preferably, the past route information includes a first traveled distance from a starting point to the specific point on the past route or a first relative distance from the point of occurrence of the first event, and the current route information includes a second traveled distance from a starting point to each of the plurality of points on the current route or a second relative distance from the point of occurrence of the second event, wherein the distance calculation unit calculates the shortest route length by referring to the first and second traveled distances or the first and second relative distances. With this configuration, since the route length calculation apparatus need not reexamine the route between the event occurrence points, the amount of computation required for the calculation of the route length can be reduced.

According to another aspect of the present invention, there is provided a route length calculation method for calculating the shortest route length between a plurality of points of occurrence of events relating to a mobile object. The route length calculation method includes: detecting the occurrence of a first event; storing, upon occurrence of the first event, past route information indicating a past route which is a route traveled by the mobile object when the mobile object passed the point of occurrence of the first event; detecting the occurrence of a second event; upon detecting the occurrence of the second event, acquiring the location of the point of occurrence of the second event; and upon detecting the occurrence of the second event, calculating the shortest route length between the point of occurrence of the first event and the point of occurrence of the second event along the past route if it is determined from the past route information, in conjunction with the point of occurrence of the second event, that the point of occurrence of the second event is located on the past route.

According to a further aspect of the present invention, there is provided a recording medium having a program recorded thereon for causing a computer to calculate the shortest route length between a plurality of points of occurrence of events relating to a mobile object. The route length calculation program recorded on the recording medium causes the computer to execute: detecting the occurrence of a first event; storing, upon occurrence of the first event, past route information indicating a past route which is a route traveled by the mobile object when the mobile object passed the point of occurrence of the first event; detecting the occurrence of a second event; upon detecting the occurrence of the second event, acquiring the location of the point of occurrence of the second event; and upon detecting the occurrence of the second event, calculating the shortest route length between the point of occurrence of the first event and the point of occurrence of the second event along the past route if it is determined from the past route information, in conjunction with the point of occurrence of the second event, that the point of occurrence of the second event is located on the past route.

According to a still further aspect of the present invention, there is provided an automotive air conditioner. The air conditioner includes: an air-conditioning unit for supplying conditioned air into a vehicle; a location information acquiring unit for acquiring location information indicating the location of the vehicle; a storage unit for storing past route information indicating a past route, which is a route traveled by the vehicle when the vehicle passed an operation point where a specific setting operation was performed by a vehicle occupant, and location information indicating the location of the operation point; a learning unit for constructing a probabilistic model into which the location information is entered in order to calculate the probability of the occupant performing the specific setting operation; a control information correcting unit for calculating the probability by entering the vehicle's current location information acquired by the location information acquiring unit into the probabilistic model constructed by the learning unit, and for correcting setting information or control information related to the occupant's setting operation in accordance with the probability so as to achieve the specific setting operation; and an air-conditioning control unit for controlling the air-conditioning unit in accordance with the corrected setting information or control information. Here, the learning unit includes: a distance calculation subunit for constructing a distance reference table recording the shortest route length between operation points by calculating along the past route the shortest route length between a current operation point, which is acquired by the location information acquiring unit each time the specific setting operation is performed by the occupant, and a past operation point, at which the specific setting operation was performed on the past route, if it is determined from the acquired current operation point and the past route information stored in the storage unit that the current operation point is located on the past route; a clustering subunit for classifying the operation points into at least a first cluster and a second cluster by referring to the distance reference table, and for determining a first range of vehicle location based on the operation points contained in the first cluster and a second range of vehicle location based on the operation points contained in the second cluster; and a probabilistic model constructing subunit for constructing the probabilistic model associated with the specific setting operation by determining the probability for the vehicle location contained in the first range and the probability for the vehicle location contained in the second range. According to the automotive air conditioner of the present invention, since the probabilistic model is generated by obtaining, based only on the routes that the vehicle has traveled before, the shortest route length between the plurality of operation points where the setting operation was performed, and by determining the class into which the vehicle location falls based on the result of the clustering of the operation points performed using the shortest route length, the range where the specific situation is expected to occur can be accurately defined.

According to a yet further aspect of the present invention, there is provided a controller for an apparatus mounted in a mobile object. The controller includes: a location information acquiring unit for acquiring location information indicating the location of the mobile object; a storage unit for storing past route information indicating a past route, which is a route traveled by the mobile object when the mobile object passed an operation point where a specific setting operation relating to the apparatus was performed, and location information indicating the location of the operation point; a learning unit for constructing a probabilistic model into which the location information is entered in order to calculate the probability of performing the specific setting operation on the apparatus; a control information correcting unit for calculating the probability by entering the mobile object's current location information acquired by the location information acquiring unit into the probabilistic model constructed by the learning unit, and for correcting setting information or control information related to the setting operation of the apparatus in accordance with the probability so as to achieve the specific setting operation; and a control unit for controlling the apparatus in accordance with the corrected setting information or control information. Here, the learning unit includes: a distance calculation subunit for constructing a distance reference table recording the shortest route length between operation points by calculating along the past route the shortest route length between a current operation point, which is acquired by the location information acquiring unit each time the specific setting operation is performed, and a past operation point, at which the specific setting operation was performed on the past route, if it is determined from the acquired current operation point and the past route information stored in the storage unit that the current operation point is located on the past route; a clustering subunit for classifying the operation points into at least a first cluster and a second cluster by referring to the distance reference table, and for determining a first range of mobile object location based on the operation points contained in the first cluster and a second range of mobile object location based on the operation points contained in the second cluster; and a probabilistic model constructing subunit for constructing the probabilistic model associated with the specific setting operation by determining the probability for the mobile object location contained in the first range and the probability for the mobile object location contained in the second range.

### DESCRIPTION OF THE DRAWINGS

These and other features and advantages of the present invention will be better understood by referring to the following detailed description, taken together with the drawings wherein:

FIG. 1 is a functional block diagram of a route length calculation apparatus according to a first embodiment of the present invention;

FIG. 2 is a simplified schematic diagram showing information stored in a buffer;

FIG. 3A is a schematic diagram showing a past route and a current route when the past route and the current route do not overlap;

FIG. 3B is a schematic diagram showing a past route and a current route when the past route and the current route partially overlap;

FIG. 4A is a schematic diagram showing the relationship between a current route and a past route when the end point of the past route is located between an operation point and end point of the current route;

FIG. 4B is a schematic diagram showing the relationship between a current route and a past route when the end point of the past route is located between the starting point and operation point of the current route;

FIG. 5A is a schematic diagram showing the relationship between a past route and a current route when information only on a past operation point is stored as past route information;

FIG. 5B is a schematic diagram showing the relationship between a past route and a current route when only a current operation point is used as a current route;

FIG. 6 is a diagram showing one example of a distance reference table;

FIG. 7 is a flowchart illustrating the operation of the route length calculation apparatus according to the first embodiment of the present invention;

FIG. 8 is a diagram schematically showing the configuration of an air conditioning system according to a second embodiment of the present invention;

FIG. 9 is a functional block diagram of a control unit of the air conditioning system;

FIG. 10 is a diagram showing a graph structure for one example of a probabilistic model used to automatically adjust a setting parameter in the air conditioning system;

FIG. 11A is a diagram showing a conditional probability table for a day-of-week input node in the probabilistic model shown in FIG. 10;

FIG. 11B is a diagram showing a conditional probability table for a time-segment input node in the probabilistic model shown in FIG. 10;

FIG. 11C is a diagram showing a conditional probability table for a current-location input node in the probabilistic model shown in FIG. 10;

FIG. 11D is a diagram showing a conditional probability table for an output node in the probabilistic model shown in FIG. 10;

FIG. 12 is a flowchart illustrating the operation of the air conditioning system according to the second embodiment of the present invention; and

FIG. 13 is a flowchart illustrating the operation of the air conditioning system according to the second embodiment of the present invention.

### DETAILED DESCRIPTION OF THE PREFERRED EMBODIMENT

A route length calculation apparatus according to the present invention will be described below with reference to the drawings. However, it should be noted that the present invention is not limited by the description given herein, but embraces the inventions described in the appended claims and their equivalents.

A route length calculation apparatus according to a first embodiment of the present invention will be described below.

The route length calculation apparatus according to the first embodiment of the present invention is mounted, for example, in a vehicle, and calculates the route length between a plurality of points based only on the routes that the vehicle has traveled before. For this purpose, when an event to be recorded occurs (for example, the temperature setting of the air conditioner is changed or the air conditioner is set to the inside air recirculation mode), the route length calculation apparatus stores the route the user is currently traveling by associating it with that event. Thereafter, when a new event occurs, the route length calculation apparatus checks whether the point of occurrence of that new event is located on the stored route. If the point of occurrence of the new event is located on the stored route, the route length calculation apparatus calculates along that route the distance to the point of occurrence of the event associated with the same route. Then, the route length calculation apparatus calculates the shortest route length between the two event occurrence points along the route the vehicle has traveled, and uses it as information for determining the geographical relationship between the events.

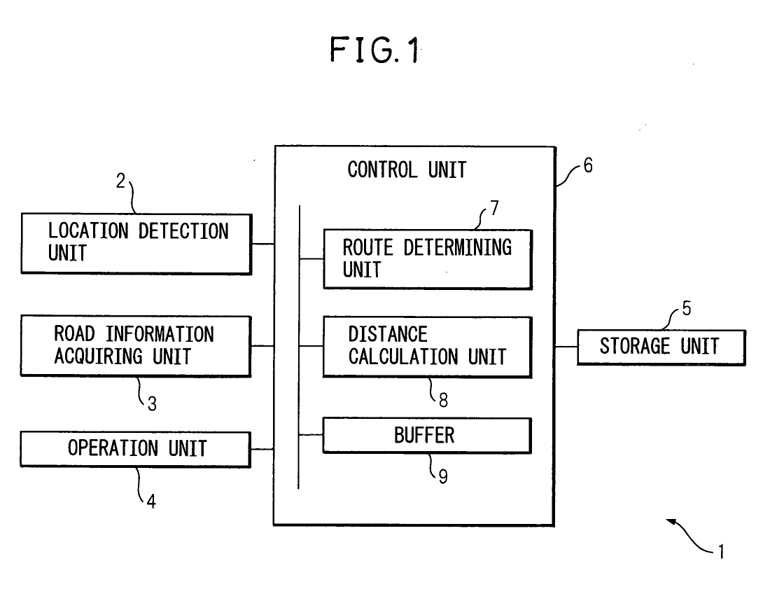

FIG. 1 is a functional block diagram showing the general configuration of the route length calculation apparatus 1. As shown in FIG. 1, the route length calculation apparatus 1 includes a location detection unit 2, a road information acquiring unit 3, an operation unit 4, a storage unit 5, and a control unit 6.

The location detection unit 2 detects the current location and heading direction of the vehicle equipped with the route length calculation apparatus 1. For this purpose, the location detection unit 2 includes sensors, such as a geomagnetic sensor, a gyroscope, and a distance sensor, and a GPS receiver. The geomagnetic sensor is used to acquire absolute heading, while the gyroscope is used to detect relative heading. The distance sensor is used to calculate traveled distance from a starting point, based on vehicle speed pulse signals. On the other hand, the GPS receiver obtains the latitude and longitude of the vehicle's current location, based on the information received from GPS satellites forming the GPS (Global Positioning System). By combining these pieces of information, the location detection unit 2 detects the current location and heading direction of the vehicle. The geomagnetic sensor, the gyroscope, the distance sensor, and the GPS receiver are well known in the art, and therefore, will not be discussed in detail here. The method of detecting the vehicle's location and heading direction by combining the information from the various sensors is also known in the art, and will not be discussed in detail here.

The location detection unit 2 detects the current location and heading direction of the vehicle at predetermined intervals of distance (for example, every 50 meters) or predetermined intervals of time (for example, every five seconds) for transmission to the control unit 6. The current location and the heading direction will hereinafter be referred to as the location information.

The road information acquiring unit 3 acquires a road map containing the road information for an area surrounding the vehicle's current location, and transmits the road map to the control unit 6. For this purpose, the road information acquiring unit 3 includes, for example, a optical recording medium such as a DVD or a CD with map information recorded thereon and a device for reading the recording medium. Here, the road information comprises nodes that indicate intersections and links that indicate roads connecting between the respective intersections. Each node is associated with identification information for the node, the position of the node, identification information for the links connected to the node, etc. Each link is associated with identification information for the link, the position and length of the link, the type of the road (for example, an ordinary road or an expressway), information concerning one-way traffic, etc. The road information acquiring unit 3 may be configured to acquire the map information from a server via a radio communication network.

The operation unit 4 functions as an event detector, and detects whether the vehicle's occupant has performed any operation. For this purpose, the operation unit 4 is constructed as an operation unit of a vehicle-mounted apparatus or an operation device of the vehicle. The kinds of operations to be detected here may be operations performed on any one of vehicle-mounted apparatus, for example, operations for changing the setting of the air conditioner (changing the temperature setting, adjusting the airflow level or airflow direction, setting the air conditioner to the inside air recirculation mode or the outside air inlet mode, etc.) or car audio-related operations (turning on or off car audio power, listening to the radio, operating the CD, adjusting the volume level, etc.). Or the operations may be operations related to vehicle driving, for example, depressing the brake pedal, accelerating or decelerating, operating the wipers, or opening or closing power windows.

Upon detecting that the occupant has performed any one of such operations, the operation unit 4 sends a signal indicating the kind of the operation to the control unit 6.

The storage unit 5 comprises, for example, an alterable non-volatile semiconductor memory or a magnetic recording medium and a device for reading it. The storage unit 5 is used to store a program to be executed by the control unit 6 and various kinds of setup parameters used in the program. Further, the storage unit 5 functions as a route history information storage unit, and stores route history information obtained by the control unit 6 and indicating the routes that the vehicle has traveled in the past.

The control unit 6 includes one or more microcomputers not shown, each comprising a CPU, ROM, RAM, etc., and their peripheral circuits. The control unit 6 includes a route determining unit 7 and a distance calculation unit 8 as functional modules implemented by a computer program which is executed on the microcomputer. The control unit 6 further includes a buffer 9 formed from a ring buffer for temporarily storing location information concerning a plurality of points on the route that the vehicle has traveled over a predetermined segment up to the vehicle's current location.

The operation of the control unit 6 will be described in detail below.

Each time the location information is acquired from the location detection unit 2, the route determining unit 7 performs map matching by comparing the location information with the road information acquired from the road information acquiring unit 3. Then, based on the result of the map matching, the route determining unit 7 associates the location information with any one of the links or nodes contained in the road information. Since a known method can be used for map matching, the details of the map matching will not be described here.

When the location information is associated with a link or node, the route determining unit 7 stores the location information in the buffer 9 together with its associated link or node. Once the location information has been stored in the buffer 9 for a predetermined number of points (for example, 10 points), the oldest location information is deleted from the buffer 9 as new location information is stored in the buffer 9.

When an operation signal indicating that some kind of operation has been performed is sent from the operation unit 4 to the control unit 6, the route determining unit 7 acquires the vehicle's location information associated with that operation from the location detection unit 2, and stores it in the buffer 9 together with operation identifying information for identifying the kind of the operation performed. The vehicle's location where the operation is performed is hereinafter referred to as the operation point. Here, the route determining unit 7 may take, as information indicating the operation point, the location information acquired at the time closest to the time that the control unit 6 received the operation signal from the operation unit 4.

After the operation, when the location information has been stored in the buffer 9 for half the predetermined number of points, the route determining unit 7 takes the location information currently held in the buffer 9 and stores it as one route history information in the storage unit 5. As a result, one route history information contains the location information for the operation point and the location information for an approximately equal number of points (for example, five points) before and after the operation point along the route. Each set of location information contained in the route history information is associated with the link or node representing the information of the road. The route history information further contains the operation identifying information for the operation performed. Here, if the distance from the starting point to the end point of the route contained in one route history information is too short, then even when there is relevance between the operations performed at different operation points, the route length calculation apparatus 1 cannot obtain the route length between the operation points. In view of this, the distance from the starting point to the end point of the route contained in one route history information can be set, for example, to a maximum distance at which the operations performed at different operation points may have relevance to each other.

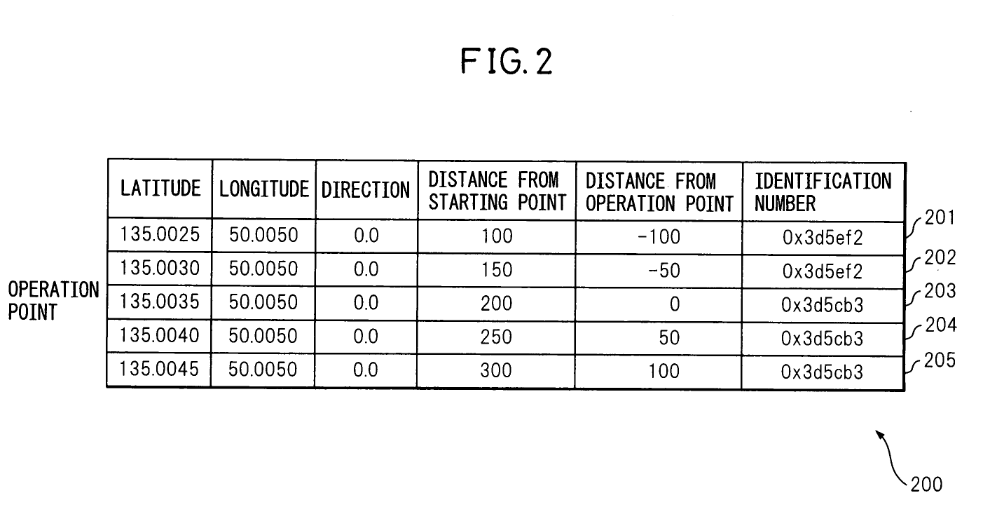

FIG. 2 shows one example of the information stored in the buffer 9. For simplicity, it is assumed in this example that the location information for only five points is stored in the buffer 9. As shown in FIG. 2, five sets of location information, 210 to 205, are stored in the respective rows in a table 200. Each set of location information carries the latitude and longitude information acquired from the GPS receiver, the direction indicating the heading direction of the vehicle, the distance from the starting point acquired from the distance sensor, the relative distance from the operation point, and the identification number of the link or node.

Each time an operation is performed via the operation unit 4, the route determining unit 7 creates new route history information and stores it in the storage unit 5 by repeating the above process and.

The distance calculation unit 8 calculates the shortest route length between two operation points. Therefore, when at least one route history information is stored in the storage unit 5, if a new operation is performed the distance calculation unit 8 reads out the route history information from the storage unit 5. The operation point and the route history information for the newly performed operation will hereinafter be referred to as the current operation point and the current route information, respectively, and the route history information read out of the storage unit 5 and the operation point contained therein will hereinafter be referred to as the past route information and the past operation point, respectively. Then, the distance calculation unit 8 checks whether the distance between a given point contained in the current route information and any one of the points contained in the past route information is not greater than a predetermined threshold value (for example, 10 meters). If the distance is not greater than the predetermined threshold value, the distance calculation unit 8 determines that there is a matching point between the current route and the past route. When a matching point is found, the distance calculation unit 8 calculates the shortest route length between the current operation point and the past operation point by using a route searching method such as Dijkstra's algorithm based only on the routes contained in the current route information and the past route information.

The distance calculation unit 8 may be configured to search the points contained in the past route information for a point closest to the attention point in the current route information by using a binary search method. Alternatively, the distance calculation unit 8 may determine whether there is a matching point between the current route and the past route by checking whether any link or node identification number contained in the current route information matches one of the link or node identification numbers contained in the past route information. In this case, the distance calculation unit 8 can distinguish between an expressway and a public road running parallel to the expressway.

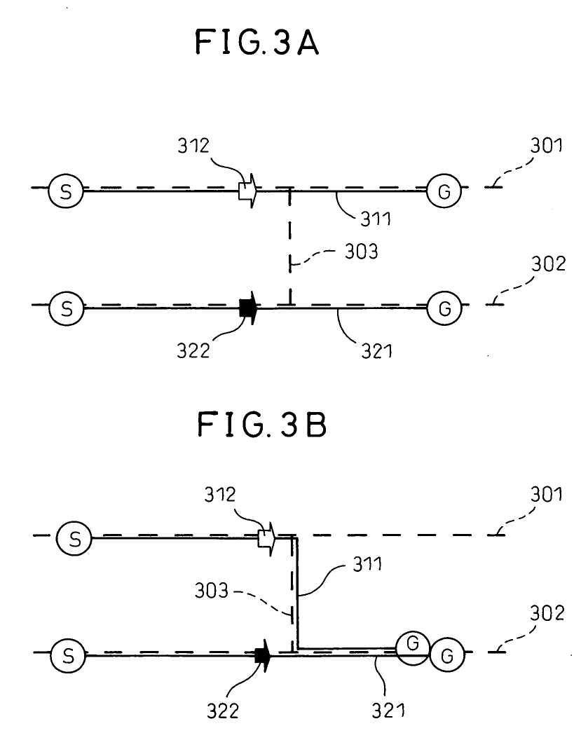

This will be explained below with reference to FIG. 3. FIG. 3A is a schematic diagram showing the past route and the current route when the past route and the current route do not overlap, and FIG. 3B is a schematic diagram showing the past route and the current route when the past route and the current route partially overlap. In FIGS. 3A and 3B, dashed lines 301 to 303 each indicate a road. Solid line 311 indicates the past route, and an open arrow 312 shown on the solid line 311 indicates the past operation point. Likewise, solid line 321 indicates the current route, and an arrow 322 shown on the solid line 321 indicates the current operation point. On each of the past and current routes 311 and 321, symbol “S” represents the starting point of the route taken, and symbol “G” represents the end point.

First, as shown in FIG. 3A, when the past route 311 runs along the road 301, and the current route 321 along the road 302, that is, when there is no overlapping between the past route 311 and the current route 321, the vehicle passing the past operation point 312 cannot get to the current operation point 322 by taking only the routes that it has traveled before. In this case, the distance calculation unit 8 determines that the distance between the past operation point 312 and the current operation point 322 is infinite. The reason is that it is highly probable that there is no relevance between the operation performed at the past operation point 312 and the operation performed at the current operation point 322.

On the other hand, in FIG. 3B, the past route 311 branches off from the road 301 and leads to the road 302 via the road 303, and the past route 311 thus overlaps the current route 321 along the way. Accordingly, the vehicle passing the past operation point 312 can get to the current operation point 322 by taking the past and current routes 311 and 321. The distance calculation unit 8 therefore calculates the shortest route length between the current operation point and the past operation point along these routes.

Each time a new operation is performed, the distance calculation unit 8 in accordance with the above procedure calculates the distance along the shortest route from the current operation point to each past operation point contained in the past route information stored. Then, the distance calculation unit 8 reads the storage unit 5 to retrieve a distance reference table storing the distances between various operation points, and adds the newly obtained distance between the current operation point and each past operation point to the distance reference table. The distance calculation unit 8 stores the thus updated distance reference table in the storage unit 5.

Here, the distance calculation unit 8 may calculate the shortest route length between the operation points by a method different from the above-described procedure. Such a different method will be described. According to this different method, when storing the route history information in the storage unit 5, information for only three points, i.e., the past operation point and the starting point and end point of the predetermined segment substantially centered about the past operation point. Then, the distance calculation unit 8 determines whether the current route coincides with the past route by checking whether any one of the three points matches the road information associated with any one of the points contained in the current route information, that is, whether any one of the three points is located on the current route. If the past operation point is located on the current route, the distance calculation unit 8 calculates the distance from the past operation point to the current operation point along the current route. On the other hand, if the starting point of the past route is located on the current route, the distance calculation unit 8 calculates the distance between the two operation points by adding the distance between the starting point and the current operation point to or subtracting it from the distance between the starting point and the past operation point. Similarly, if the end point of the past route is located on the current route, the distance calculation unit 8 calculates the distance between the two operation points by adding the distance between the end point and the current operation point to or subtracting it from the distance between the end point and the past operation point.

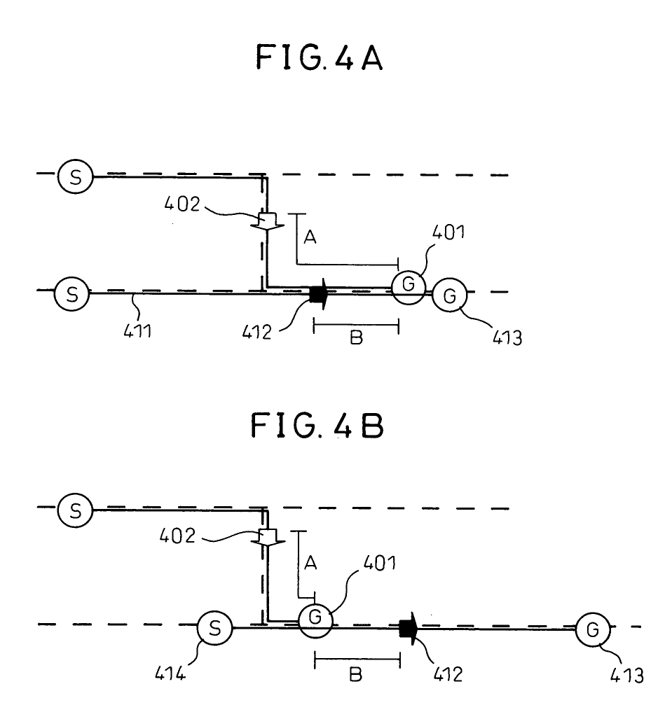

An example of implementation of the above different method will be described below with reference to FIGS. 4A and 4B. FIG. 4A is a schematic diagram showing the relationship between the current route and the past route when the end point 401 of the past route is located on the current route 411 indicated by a solid line and when the operation point 412 on the current route 411 is located nearer the past operation point 401 than the end point 401 of the past route is (that is, the end point 401 of the past route is located between the operation point 412 and the end point 413 of the current route 411). Likewise, FIG. 4B is a schematic diagram showing the relationship between the current route and the past route when the end point 401 of the past route is located on the current route 411 and when the operation point 412 on the current route 411 is located beyond the end point 401 of the past route (that is, the end point 401 of the past route is located between the starting point 414 and the operation point 412 of the current route 411).

In the example shown in FIG. 4A, the segment (distance B) from the operation point 412 to the end point 401 of the past route overlaps the segment (distance A) from the past operation point 402 to the end point 401. Therefore, the distance calculation unit 8 calculates the distance d between the operation point 412 and the past operation point 402 as (A−B).

On the other hand, in the example shown in FIG. 4B, the segment (distance B) from the operation point 412 to the end point 401 of the past route and the segment (distance A) from the past operation point 402 to the end point 401 do not overlap each other. Therefore, the distance calculation unit 8 calculates the distance d between the operation point 412 and the past operation point 402 as (A+B).

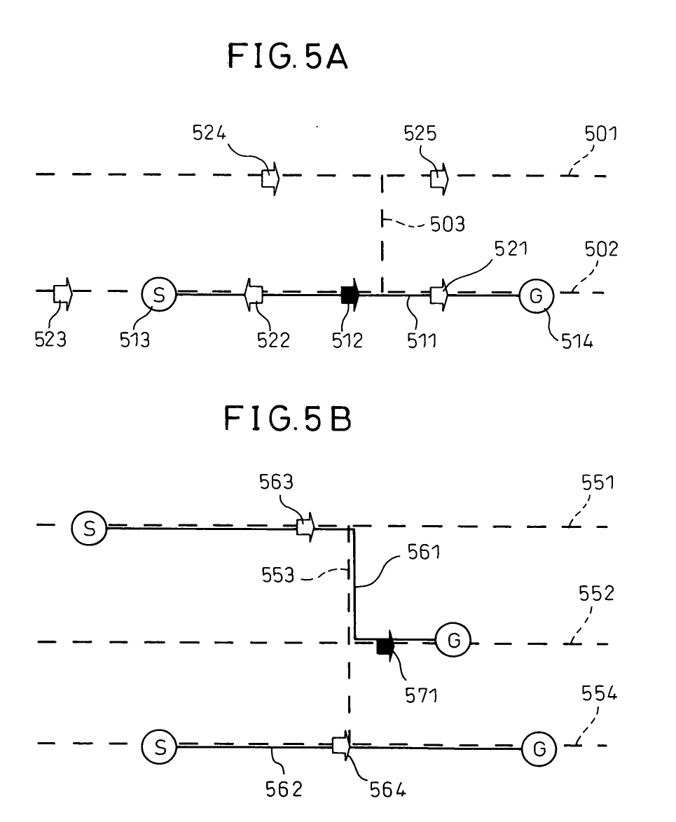

Alternatively, the distance calculation unit 8 may determine whether the current route coincides with the past route by using only the location information of the operation point on either the current route or the past route. Such methods will be described with reference to FIGS. 5A and 5B. FIG. 5A is a schematic diagram showing the relationship between the past route and the current route when information only on the past operation point is stored for use as the past route information. FIG. 5B is a schematic diagram showing the relationship between the past route and the current route when only the current operation point is used as the current route information.

In FIG. 5A, dashed lines 501 to 503 each indicate a road. Solid line 511 drawn along the road 502 indicates the current route, and an arrow 512 shown on the solid line 511 indicates the current operation point. It is assumed here that the vehicle has traveled from the starting point 513 to the end point 514 of the current route 511. Open arrows 521 to 525 indicate past operation points. The directions of the arrows representing the current operation point 512 and the past operation points 521 to 525 each indicate the heading direction of the vehicle.

In the method shown in FIG. 5A, when any past operation point is located on the current route, the distance calculation unit 8 calculates the distance from the current operation point to the past operation point along the current route. In FIG. 5A, the past operation points 521 and 522 are located on the current route 511, but the other past operation points 523 to 525 are located away from the current route 511. Therefore, the distance calculation unit 8 calculates the distance from the current operation point 512 to the past operation point 521 or 522 along the current route 511, and determines that the distance from the current operation point 512 to any of the other past operation points 523 to 525 is infinite.

Next, the example shown in FIG. 5B will be described. In FIG. 5B, dashed lines 551 to 554 each indicate a road. The solid line 561 leading from the road 551 to the road 552 via the road 553 and the solid line 562 drawn along the road 554 indicate the past routes. Open arrows 563 and 564 indicate the past operation points on the past routes 561 and 562, respectively. An arrow 571 indicates the current operation point. The directions of the arrows representing the current operation point 571 and the past operation points 563 and 564 each indicate the heading direction of the vehicle.

In the method shown in FIG. 5B, when the current operation point is located on any one of the past routes, the distance calculation unit 8 calculates the distance from the current operation point to the past operation point along that past route. In FIG. 5B, since the current operation point 571 is located on the past route 561, the distance calculation unit 8 calculates the distance from the current operation point 571 to the past operation point 563 along the past route 561. On the other hand, since the current operation point 571 does not match any one of the points on the past route 562, the distance calculation unit 8 determines that the distance from the current operation point 571 to the past operation point 564 is infinite.

These alternative methods can reduce the amount of data to be stored in the storage unit 5 or to be used for the calculation. Furthermore, the distance calculation unit 8 need not search for the route between the current operation point and the past operation point in order to obtain the shortest route between the current operation point and the past operation point. The distance calculation unit 8 can obtain the distance between the current operation point and the past operation point by referring to the distance from the starting point to the location of each operation point, or to the relative distance from one of the operation points, that is carried in the current route information or the past route information. Accordingly, these methods are effective in reducing hardware resources, particularly when there are few intersections and when the current route and the past route do not separate from each other or merge together along the way.

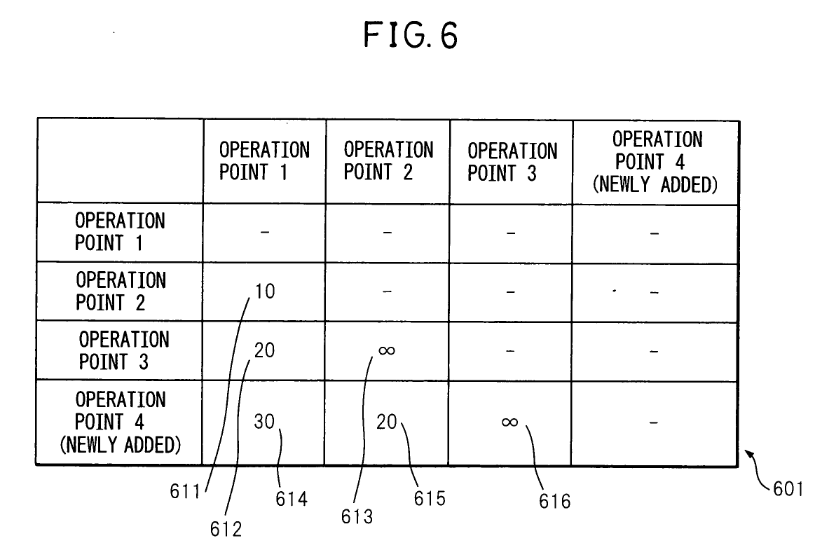

FIG. 6 shows one example of the distance reference table storing the distances between various operation points. In FIG. 6, the operations points 1 to 3 shown in the uppermost row and leftmost column of the distance reference table 601 correspond to the past operation points contained in the past route information. The operation point 4 represents the current operation point. The numeric values stored in the entries 611 to 613 of the distance reference table 601 indicate the distances between the past operation points. The entries 614 to 616 in the lowermost row store the distances between the newly added current operation point 4 and the previously stored past operation points 1 to 3, respectively.

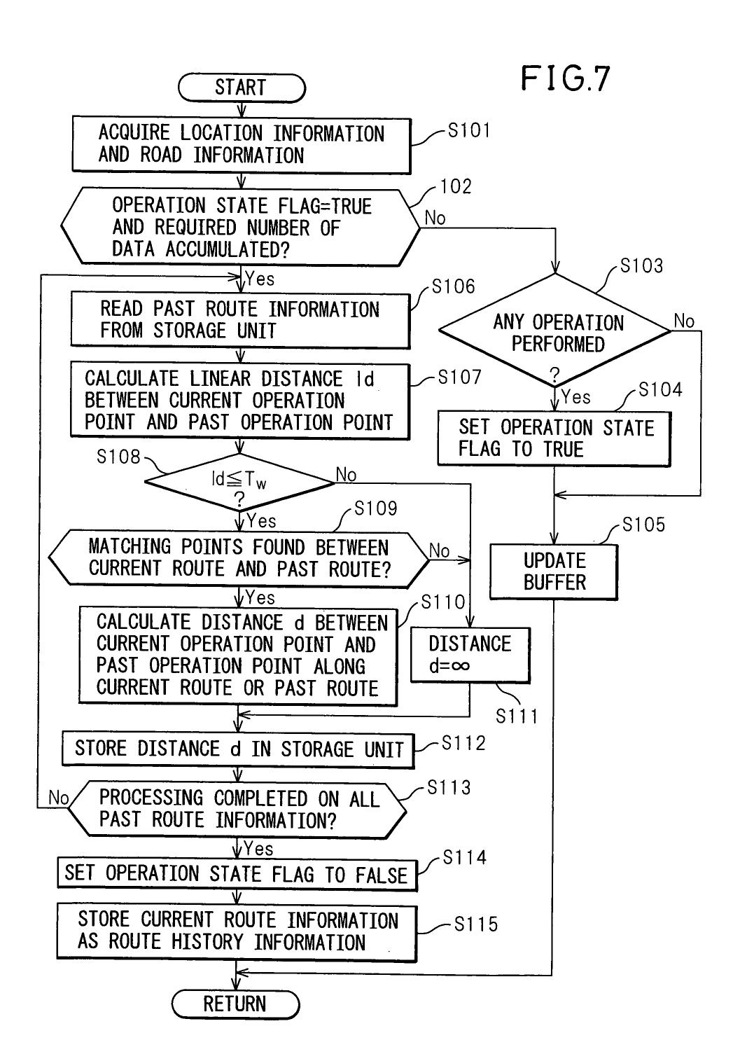

The operation of the route length calculation apparatus 1 according to the first embodiment of the present invention will be described below with reference to the flowchart shown in FIG. 7. The operation of the route length calculation apparatus 1 is controlled by the control unit 6 in accordance with a computer program incorporated in the control unit 6.

First, the control unit 6 acquires vehicle location information (more specifically, the latitude and longitude representing the location of the vehicle, the traveled distance from the staring point, and the heading direction) from the location detection unit 2, and acquires road information from the road information acquiring unit 3 (step S101).

Next, the control unit 6 checks whether the value of an operation state flag is true (which indicates that an operation point is contained in the route information stored in the buffer 9) and whether information for a predefined number of points has been acquired after the operation (that is, whether current route information has been created or not) (step S102). If the value of the operation state flag is false (which indicates that no operation points are contained in the route information stored in the buffer 9), or if sufficient data is not collected for the creation of the current route information, the control unit 6 then checks whether any kind of operation has been performed from the operation unit 4 (step S103). If any kind of operation has been performed, the control unit 6 sets the value of the operation state flag to true (S104). After step S104, or if it is determined in step S103 that no operation has been performed, the route determining unit 7 in the control unit 6 matches the location information with the road information acquired in step S101 and, using them, updates the information stored in the buffer 9 (step S105). After that, the control unit 6 terminates the operation process.

On the other hand, if, in step S102, the value of the operation state flag is true, and the creation of the current route information is completed, the control unit 6 reads out one of the route history information stored in the storage unit 5 and takes it as past route information (step S106). Then, the distance calculation unit 8 in the control unit 6 obtains the linear distance id between the current operation point contained in the current route information and the past operation point contained in the past route information (step S107). After that, the distance calculation unit 8 checks whether the linear distance ld is not greater than a predetermined threshold value Tw (step S108). Here, the threshold value Tw is set equal to a distance beyond which the current operation point can be considered as having no relevance to the past operation point. For example, the threshold value Tw can be set equal to the distance between the starting point and end point contained in the current route information or past route information. If the linear distance ld is greater than the threshold value Tw, the distance calculation unit 8 sets the distance d between the current operation point and the past operation point to infinity (step S111). Then, the control unit 6 passes control to step S112. In this way, when the linear distance id between the current operation point and the past operation point is great enough that the operation performed at the current operation point is considered to have no relevance to the operation performed at the past operation point, the amount of computation required for the calculation of the distance can be reduced by forcefully setting the distance between the two operation points to a sufficiently large value. On the other hand, if, in step S108, the linear distance ld is not greater than the threshold value Tw, the distance calculation unit 8 checks whether any point contained in the current route matches any one of the points contained in the past route (step S109). If none of the points contained in the current route match any one of the points contained in the past route, the distance calculation unit 8 sets the distance between the current operation point and the past operation point to infinity (step S111). Then, the control unit 6 passes control to step S112.

On the other hand, if there are matching points between the current route and the past route in step S109, the distance calculation unit 8 searches for the shortest route between the two operation points along the current route or the past route, and calculates the distance (that is, the shortest route length) d between the two operation points along the shortest route (step S110). Then, the control unit 6 writes the calculated distance d to the distance reference table, and stores the thus updated distance reference table in the storage unit 5 (step S112).

After step S112, the control unit 6 checks whether the above process from step S106 to step S112 has been completed on all the route history information stored in the storage unit 5 (step S113). If there is any route history information for which the process from step S106 to step S112 has not yet been performed, the control unit 6 returns control to step S106, and the process from step S106 to step S112 is performed for such route history information.

On the other hand, if it is determined in step S113 that the process from step S106 to step S112 has been completed on all the route history information, the control unit 6 changes the value of the operation state flag to false (step S114). Then, the control unit 6 transfers the current route information held in the buffer 9 to the storage unit 5 where it is stored as additional route history information (step S115), after which the process is terminated.

The control unit 6 performs the above process from step S101 to S115 each time the location information is acquired.

In the above flowchart, the process from step S107 to step S108 may be omitted. Further, in steps S109 and S110, the distance calculation unit 8 may calculate the shortest route length between the operation points in accordance with the method described with reference to FIG. 4 or 5. Furthermore, in step S111, rather than setting the distance d between the operation points to infinity, the distance calculation unit 8 may set it to a sufficiently large finite value that indicates that there is no relevance between the two operations.

As described above, the route length calculation apparatus according to the first embodiment of the present invention checks whether the current route coincides with the past route, and calculates the distance between the current operation point and the past operation point only when the two routes coincide; accordingly, the shortest route length between the operation points can be calculated along the route that the vehicle has actually traveled.

The present invention is not limited to the above specific embodiment. For example, the distance calculation unit 8 may determine whether the current route coincides with the past route, not only based on the above criteria but also by checking whether the heading direction of the vehicle matches. For example, in the example shown in FIG. 5A, the heading direction of the vehicle at the past operation point 522 is opposite to the heading direction of the vehicle traveling along the current route 511. In this case, the distance calculation unit 8 may determine that the past operation point 522 and the current route 511 do not match. Here, the distance calculation unit 8 determines whether the heading direction matches, based on the heading direction of the vehicle at the point where the current route coincides with the past route. For example, when the road information associated with that point is a link, if the difference in the direction indicating the heading direction of the vehicle is smaller than 90°, the distance calculation unit 8 determines that the heading direction of the vehicle on the current route coincides with the heading direction of the vehicle on the past route. On the other hand, if the difference in the direction is larger than 90°, the distance calculation unit 8 determines that the heading direction of the vehicle on the current route does not coincide with the heading direction of the vehicle on the past route. When the road information associated with that point is a node (that is, an intersection), then if the difference in the direction indicating the heading direction of the vehicle is smaller than 30°, the distance calculation unit 8 determines that the heading direction of the vehicle on the current route coincides with the heading direction of the vehicle on the past route. On the other hand, if the difference in the direction is larger than 30°, the distance calculation unit 8 determines that the heading direction of the vehicle on the current route does not coincide with the heading direction of the vehicle on the past route.

For operations performed in a specific area such as a park or a parking lot of a shopping center, the distance calculation unit 8 need not necessarily calculate the distance between the operation points.

Further, the distance calculation unit 8 may calculate the distance between the current operation point and the past operation point in accordance with one of the above methods only when the operation performed at the current operation point is the same as the operation performed at the past operation point. Then, if the operation performed at the current operation point is not the same as the operation performed at the past operation point, the distance calculation unit 8 may set the distance between the current operation point and the past operation point to a sufficiently large finite value (for example, infinity) that indicates that there is no relevance between the two operations. By thus adding the kind of the operation (i.e., the kind of the event) as a criterion for determining whether to calculate the route length or not, the number of combinations of operation points for which the route length has to be actually calculated can be reduced, which serves to reduce the amount of processing in the distance calculation unit 8.

Further, instead of calculating the distance between the current operation point and the past operation point, the route length calculation apparatus 1 may obtain a minimum value of the link cost along the route jointing the two operation points by referring to the road information. In that case, the route length calculation apparatus 1 can examine the positional relationship between the two operation points by considering the road width, the presence or absence of traffic congestion, etc. Further, the route length calculation apparatus 1 may include an altimeter or the like. Then, when there are a plurality of roads running parallel to each other and one above another, such as an elevated road and a ground road, the route length calculation apparatus 1 may utilize the altitude information obtained by the altimeter in order to determine which of the roads the vehicle has traveled. There are also cases where a plurality of operations are performed successively and, as a result, a plurality of operation points are contained in one route history information. In such cases, each time an operation is detected via the operation unit 4, the control unit 6 creates a copy of the route information stored in the buffer so that one route history information can be created for each operation. Thereafter, the route length calculation apparatus 1 may add location information to the respective route information in parallel fashion until the creation of the route history information for the respective operation points is completed.

Next, an automotive air conditioning system according to a second embodiment of the present invention will be described. The air conditioning system, which takes the current location of the vehicle as an input, estimates the air conditioner setting appropriate to a specific place by using a probabilistic model that outputs the probability of the air conditioner setting that is considered appropriate to the vehicle location, and automatically changes the air conditioner setting in accordance with the result of the estimation. Here, to generate the probabilistic model, the air conditioning system stores information indicating the vehicle's location (operation point) each time the occupant changes the air conditioner setting. Then, the air conditioning system obtains the shortest route length between the respective operation points in the same manner as the route length calculation apparatus 1 described above. After that, by clustering the locations of the operation points based on the shortest route length between the respective operation points, the air conditioning system determines the class of the value of the location information to be entered into the probabilistic model. Finally, the air conditioning system generates the probabilistic model by determining the probability for each class.

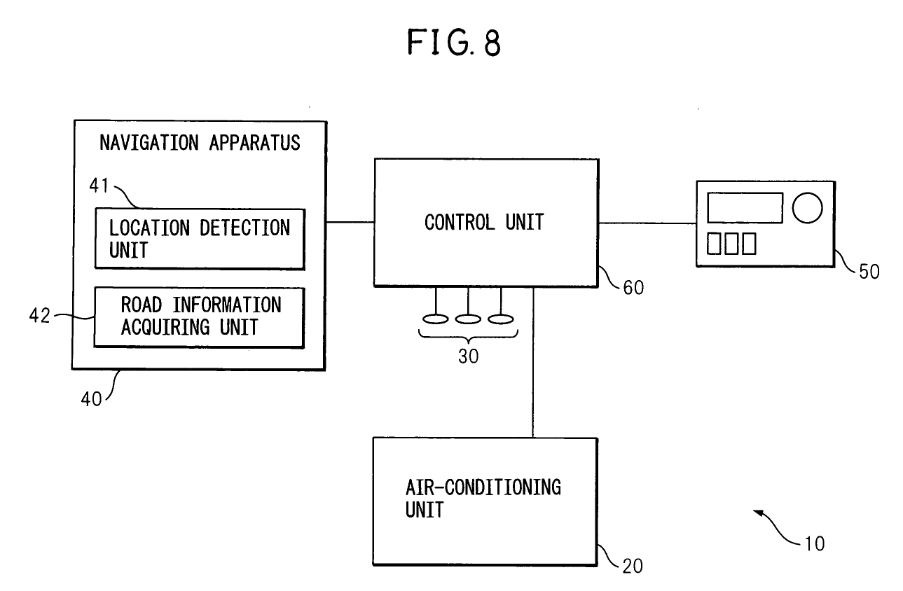

FIG. 8 is a diagram schematically showing the configuration of the air conditioning system 10 according to the second embodiment of the present invention. As shown in FIG. 8, the air conditioning system 10 includes an air-conditioning unit 20 comprised mainly of mechanical components, a sensor unit 30 for acquiring state information such as inside temperature, a navigation apparatus 40 having a location detection unit 41 and a road information acquiring unit 42, an operation panel 50 which functions as an operation unit, and a control unit 60 for controlling the various parts of the air conditioning system 10.

The air-conditioner unit 20 cools or heats air drawn in from inside or outside the vehicle and supplies the cooled or heated air into the passenger compartment. For this purpose, the air-conditioner unit 20 includes a refrigeration cycle for cooling refrigerant (the refrigeration cycle comprises a compressor, receiver, expansion valve, etc.), an air inlet and a blower fan for drawing in air from inside or outside the vehicle, an evaporator for exchanging heat between the refrigerant and the air thus drawn in, a heater core for heating the air drawn in, an air mix door for obtaining conditioned air of desired temperature by adjusting the mixing ratio between the air passing over the heater core and the air bypassing the heater core, and an air outlet for delivering the conditioned air into the passenger compartment.

Here, various known configurations used for automotive air conditioners can be employed for the air-conditioning unit 20.

The sensor unit 30 comprises sensors for acquiring various kinds of state information concerning the vehicle. Typical sensors used in the sensor unit 30 include an inside temperature sensor, an outside temperature sensor, and a solar sensor. The inside temperature sensor is mounted together with an aspirator in the instrument panel or the like at a position near the steering wheel in order to measure the temperature (inside temperature) Tᵣ inside the passenger compartment. The outside temperature sensor is mounted in the radiator grille at the front end of the vehicle in order to measure the temperature (outside temperature) Tₐₘ outside the passenger compartment. The solar sensor is mounted inside the passenger compartment at a position near the windshield in order to measure the intensity (amount) of solar radiation S entering the passenger compartment. The inside temperature Tᵣ, the outside temperature Tₐₘ, and the amount of solar radiation S measured by these sensors are used as air conditioning information in the control unit 60 to perform temperature control and airflow level control.

The sensor unit 30 may also include other sensors such as an evaporator outlet temperature sensor for measuring the temperature of the air leaving the evaporator.

The navigation apparatus 40 acquires vehicle location information and road information and sends them to the control unit 60. The location detection unit 41 and road information acquiring unit 42 provided in the navigation apparatus 40 are identical in configuration and function to the location detection unit 2 and road information acquiring unit 3, respectively, provided in the route length calculation unit 1 according to the first embodiment of the present invention. Therefore, for the details of the location detection unit 41 and the road information acquiring unit 42, reference should be made to the description given of the location detection unit 2 and the road information acquiring unit 3, respectively.

The operation unit 50 includes various switches for adjusting the setting information of the air conditioning system 10, and a display for displaying the setting information. The operation unit 50 sends a signal corresponding to the kind of the switch operation performed thereon to the control unit 60. The setting information includes, for example, set temperature Tₛₑₜ inside the passenger compartment, airflow level W, air inlet mode setting (inside air recirculation mode or outside air inlet mode), airflow direction setting, etc.

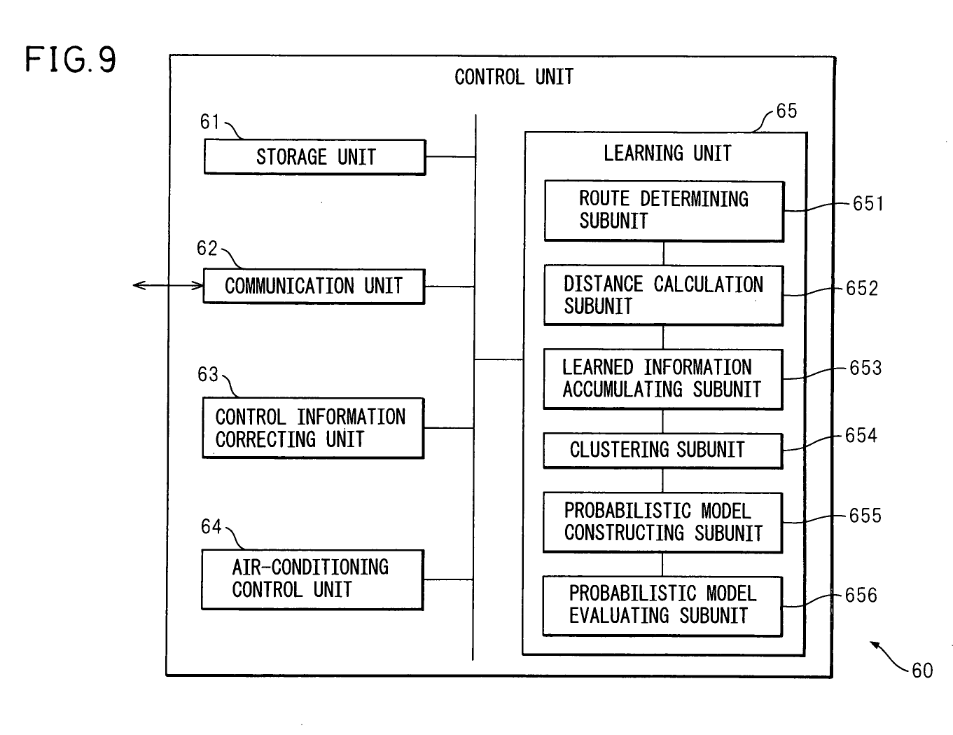

FIG. 9 is a functional block diagram of the control unit 60 of the air conditioning system 10.

The control unit 60 includes: one or more microcomputers not shown, each comprising a CPU, ROM, RAM, etc., and their peripheral circuits not shown; a storage unit 61 constructed from an electrically alterable nonvolatile memory or the like; and a communication unit 62 for performing communications with the sensor unit 30, the navigation apparatus 40, etc. in compliance with an automotive communication standard such as Control Area Network (CAN).

The control unit 60 further includes a control information correcting unit 63, an air-conditioning control unit 64, and a learning unit 65, each implemented as a functional module by a computer program executed on the microcomputer.

Upon acquiring the sensor information from the sensor unit 30, the location information and road information from the navigation apparatus 40, and the setting information from the operation unit 50, the control unit 60 temporarily stores them in the RAM. The air-conditioning control unit 64 controls the air-conditioning unit 20 based on the thus acquired information, and adjusts the ratio of the conditioned air between the various air outlets, the total amount of air, and the temperature of the conditioned air.

Here, to determine the optimum temperature, airflow level, etc. of the conditioned air when the vehicle reaches a specific place, the control information correcting unit 63 enters the state information indicating the vehicle state, such as current vehicle location, time, vehicle speed, etc., into an applicable probabilistic model, and estimates the probability that the occupant performs a specific operation (for example, to lower the temperature setting, set the airflow level to maximum, set the air conditioner to the inside air recirculation mode, etc.). If the probability is greater than a predetermined threshold value, the air conditioning system 10 automatically executes that specific operation. Further, to generate a probabilistic model, each time the occupant operates the air conditioning system 10 the learning unit 65 stores various kinds of information such as the kind of the operation performed and the vehicle location and time at the time of the operation. When such information has been accumulated a predetermined number of times, the learning unit 65 generates a probabilistic model by performing statistical learning based on the accumulated information. The functional modules for performing the above operations will be described below.

The control information correcting unit 63 determines whether the setting parameter of the air conditioner 1 should be automatically adjusted based on the probabilistic model. The setting parameter here is the setting information, such as the set temperature Tₛₑₜ, airflow level W, or inside air recirculation mode/outside air inlet mode setting, that the occupant can directly set. Then, when automatically adjusting the setting parameter, the control information correcting unit 63 corrects the setting parameter based on the correction information associated with the probabilistic model. Here, the correction information associated with the probabilistic model refers to the value of the setting parameter after correction or to the amount of correction to be added to or by which to multiply the setting parameter in order to correct the setting parameter to the desired value.

In the present embodiment, a Bayesian network is used as the probabilistic model. A Bayesian network is a network that models probabilistic causality relationships among a plurality of events and is represented by a directed acyclic graph in which propagation between each node is obtained by a conditional probability. For the details of Bayesian networks, refer to “Bayesian Network Technology” by Yoichi Motomura and Hirotoshi Iwasaki, 1st Edition, Tokyo Denki University Press, July 2006, “Introduction to Bayesian Networks” by Kazuo Shigemasu et al., 1st Edition, Baifukan, July 2006, or “Pattern Recognition” translated by Morio Onoe, 1st Edition, Shin Gijutsu Communications, July 2001.

In the present embodiment, the probabilistic model is generated for each kind of setting operation (for example, lower or raise the set temperature Tₛₑₜ, adjust the airflow level W, set the air conditioner to the inside air recirculation mode, etc.). Information showing the structure of each probabilistic model is stored in the storage unit 61 by being associated with the corresponding setting operation. More specifically, the graph structure showing the connections between the nodes forming the probabilistic model, the type of input information given to the input node, and the conditional probability table (CPT) of each node are stored in the storage unit 61. Further, the setting operation number k that uniquely corresponds to the kind of setting operation, and the setting parameter to be corrected by the setting operation and its correction value (for example, (Tₛₑₜ, −3) when lowering the set temperature Tₛₑₜ by 3° C., (W, Wₘₐₓ) when setting the air flow level W to maximum Wₘₐₓ, etc.), are defined for each probabilistic model and stored in the storage unit 61.

The control information correcting unit 63 retrieves one or more probabilistic models from the storage unit 61. The control information correcting unit 63 enters prescribed state information into each of the retrieved probabilistic models and obtains the probability that the occupant performs the setting operation associated with the probabilistic model. More specifically, the control information correcting unit 63 obtains the probability that the setting operation uniquely identified in relation to the probabilistic model and designated by the setting operation number k stored in the storage unit 61 together with that probabilistic model is performed. The control information correcting unit 63 can calculate the probability by using, for example, a belief propagation method. When the thus obtained probability is greater than or equal to a threshold value Th1 (for example, Th1=0.9) indicating that it is almost certain that the occupant will perform that setting operation, the control information correcting unit 63 automatically executes that setting operation. More specifically, the control information correcting unit 63 corrects the value of the setting parameter of that setting operation by using the correction value of the setting parameter associated with the probabilistic model (that is, the correction value of the setting parameter uniquely defined in relation to the probabilistic model and stored in the storage unit 61 together with that probabilistic model).

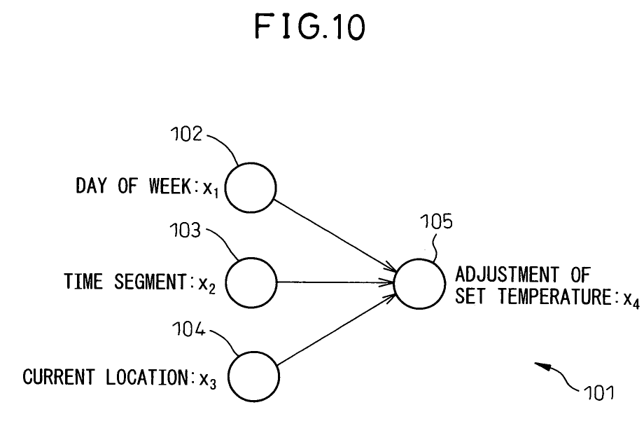

FIG. 10 shows a graph structure for one example of the probabilistic model used to automatically adjust the setting parameter of the air conditioning system 10. In the probabilistic model 101 shown in FIG. 10, three input nodes 102, 103, and 104 are connected to an output node 105. Here, day of week (X₁), time segment (X₂), and current location (X₃) are given as state information to the respective input nodes 102, 103, and 104. The output node 105 outputs the probability of the set temperature Tₛₑₜ being lowered by 3° C.

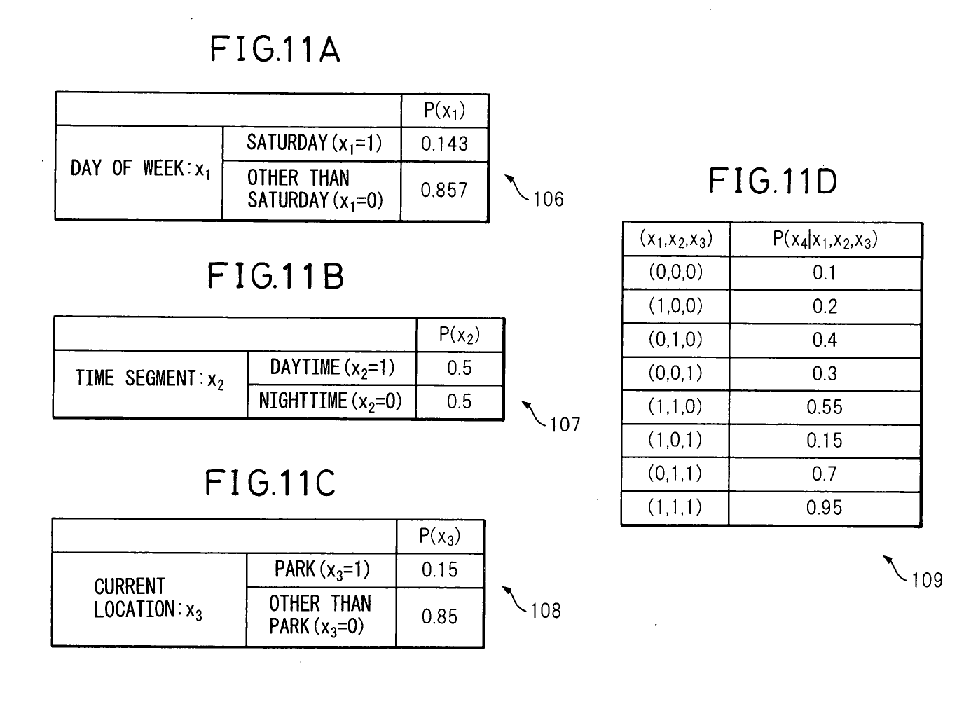

FIGS. 11A to 11D show CPTs 106 to 109 for the respective nodes in the probabilistic model 101 shown in FIG. 10. The CPTs 106 to 108 correspond to the input nodes 102 to 104, respectively, and provide the prior probabilities of the respective state information. The CPT 109 corresponds to the output node 105, and provides the distribution of the conditional probabilities allocated to the various values of the information given to the respective input nodes.

When all of the information given to the respective input nodes is known, that is, the day of week is Saturday (X₁=1), the time segment is daytime (X₂=1), and the current location is the park (X₃=1), for example, it can be seen from FIG. 11D that the probability, P(X₄=1|X₁=1, X₂=1, X₃=1), of the set temperature Tₛₑₜ being lowered by 3° C. is 0.95. Since the probability obtained here is greater than the threshold value Th1, the control information correcting unit 63 corrects the setting parameter so as to lower the set temperature Tₛₑₜ by 3° C.

On the other hand, when the day of week is Monday (X₁=0), the time segment is nighttime (X₂=0), and the current location is the office (X₃=0), it can be seen from FIG. 11D that the probability, P(X₄=1|X₁=0, X₂=0, X₃=0), of the set temperature Tₛₑₜ being lowered by 3° C. is 0.1. Since the obtained probability is smaller than the first threshold value Th1, the control information correcting unit 63 does not change the set temperature Tₛₑₜ.

In the above example, the probabilistic model has been described as having a two-layer network structure for simplicity, but the probabilistic model may have a network structure with three or more layers including an intermediate layer. Further, the classification of the state information given to the respective input nodes is not limited to the above example. The classification of the state information will be described later in connection with the learning unit 65.

When any one of the setting parameters such as the set temperature Tₛₑₜ, airflow level W, etc. is corrected as described above, the control information correcting unit 63 temporarily stores the corrected setting parameter in the RAM of the control unit 60 so that the setting parameter can be used by the various units in the control unit 60.

The air-conditioning control unit 64 reads from the RAM the setting information and the sensing information acquired from each sensor, and controls the air-conditioning unit 20 based on the readout values. Here, if the setting parameter corrected by the control information correcting unit 63 is stored in the RAM, the air-conditioning control unit 64 uses the corrected setting parameter.

More specifically, based on the set temperature Tₛₑₜ and the measurement signals acquired from the temperature sensors and the solar sensor 53, the air-conditioning control unit 64 determines the outlet temperature of the conditioned air (air conditioning temperature Tₐₒ) to be discharged from the air outlets. Then, the air-conditioning control unit 64 determines the opening of the air mix door so that the temperature of the conditioned air will become substantially identical with the air conditioning temperature Tₐₒ. The air-conditioning control unit 64 sends a control signal to a temperature control servo motor which moves the air mix door to achieve the thus determined air mix door opening.

Further, the air-conditioning control unit 64 controls the ON/OFF operation of the compressor in the refrigeration cycle, based on the air conditioning temperature Tₐₒ, set temperature Tₛₑₜ, evaporator outlet temperature, etc. When cooling the passenger compartment or operating the defroster, the air-conditioning control unit 64 usually puts the refrigeration cycle into operation by operating the compressor.

The air-conditioning control unit 64 also determines the airflow level and the airflow ratio of the conditioned air between the various air outlets, based on the air conditioning temperature Tₐₒ, set temperature Tₛₑₜ, etc. Then, the air-conditioning control unit 64 adjusts the number of revolutions of the blower fan in the air-conditioning unit 20 so as to achieve the thus determined airflow level. Further, the air-conditioning control unit 64 determines the opening of each air outlet in accordance with the determined airflow ratio. Furthermore, the air-conditioning control unit 64 determines the ratio between the air that the air conditioning system 10 draws in through the inside air inlet and the air that it draws in through the outside air inlet, based on the air conditioning temperature Tₐₒ, set temperature Tₛₑₜ, inside temperature Tᵣ, etc.

To determine the air conditioning temperature Tₐₒ, the air-conditioning control unit 64 uses a temperature control equation that defines, for example, the relationship of the air conditioning temperature Tₐₒ to the set temperature Tₛₑₜ, inside temperature Tᵣ, outside temperature Tₐₘ, and amount of solar radiation S. Further, to determine the airflow level W, the air-conditioning control unit 64 uses an airflow level control equation that defines, for example, the relationship of the airflow level W to the set temperature Tₛₑₜ, inside temperature Tᵣ, outside temperature Tₐₘ, and amount of solar radiation S. Alternatively, the air-conditioning control unit 64 can use various known control methods in order to determine the air conditioning temperature Tₐₒ and the airflow level W. Likewise, the air-conditioning control unit 64 can use various known control methods in order to determine the airflow ratio, to control the ON/OFF operation of the compressor, or to determine the inlet air ratio. Therefore, the detailed description of such control methods will not be given herein.

When the occupant operates the air conditioning system 10, the learning unit 65 determines whether a new probabilistic model is to be generated or an existing probabilistic model is to be updated, and generates or updates the probabilistic model if necessary. For this purpose, the learning unit 65 includes a route determining subunit 651, a distance calculation subunit 652, a learned information accumulating subunit 653, a clustering subunit 654, a probabilistic model constructing subunit 655, and a probabilistic model evaluating subunit 656. The various subunits contained in the learning unit 65 will be described in detail below.

The route determining subunit 651 determines, based on the location information and road information acquired from the navigation apparatus 40, the route being traveled by the vehicle passing the point (operation point) where the setting operation of the air conditioning system 10 is performed, and stores it as the route history information in the storage unit 61. On the other hand, each time the setting operation of the air conditioning system 10 is performed, the distance calculation subunit 652 calculates the distance between each operation point along the route the vehicle has traveled, constructs a distance reference table showing the distance from one operation point to the next, and stores the table in the storage unit 61. Here, the route determining subunit 651 and the distance calculation subunit 652 are identical in configuration and function to the route determining unit 7 and the distance calculation unit 8, respectively, in the first embodiment. Therefore, for the details of the route determining subunit 651 and the distance calculation subunit 652, reference should be made to the description given of the route determining unit 7 and the distance calculation unit 8 in the first embodiment. It should also be noted that the RAM contained in the control unit 60 serves the function corresponding to the buffer 9 in the first embodiment.

The learned information accumulating subunit 653 associates the acquired state information with the setting operation performed by the occupant, and stores the state information in the storage unit 61 as the learned data necessary to construct a probabilistic model for estimating the setting operation to be performed by the occupant.

Generally, when the air conditioned state of the passenger compartment is not comfortable for the occupant, the occupant tends to change the setting of the air conditioning system 10. Accordingly, when the occupant frequently changes the setting of the air conditioning system 10, it may be necessary to construct a probabilistic model for estimating the setting operation to be performed by the occupant. However, for the construction of an appropriate probabilistic model, it will become necessary to gather a sufficient amount of data in order to make a statistically correct estimation. In view of this, each time the setting of the air conditioning system 10 is changed, the learned information accumulating subunit 653 stores the acquired state information (air conditioning information, such as outside temperature Tₐₘ, and location information) as learned data Dₖ in the storage unit 61 by associating it with the setting operation number k.

The learned information accumulating subunit 653 also stores in the storage unit 61 the number, iₖ, of times that the occupant has performed the setting operation α corresponding to the setting operation number k (for example, to lower the set temperature by 3° C., set the airflow level W to maximum, or switch the air inlet mode to the inside air recirculation mode).

The learned data Dₖ and the number of times of the operation, iₖ, are stored independently of each other for each setting operation.

Of the various kinds of state information contained in the learned data Dₖ, the clustering subunit 654 performs clustering on those that cannot be classified in advance into a plurality of classes, and determines the class for the value of such state information in order to construct a CPT for each node of the probabilistic model.

There are cases where information whose possible values cannot be limited to a given pattern or whose value varies continuously, for example, the vehicle's current location information, the temperature information such as the outside temperature and the inside temperature, the time information, etc., is used as the state information to be given to an input node of the probabilistic model. To construct a CPT that takes such information as an input parameter, how the value of the input state information is to be classified becomes an important issue. For example, consider the case of constructing a probabilistic model corresponding to the setting operation for lowering the set temperature by 3° C. in a specific situation where, after doing physical exercise, the occupant gets into the vehicle parked in a parking lot of a park. In this case, to use the vehicle's location information as one of the various kinds of state information to be given to the input nodes of the probabilistic model, it is important to classify the vehicle's location information by at least differentiating the case where the vehicle is located in the parking lot of the park from the case where the vehicle is located in some other place. Similarly, consider the case of constructing a probabilistic model corresponding to the setting operation for setting the air inlet mode to the inside air recirculation mode in a specific situation where the vehicle is traveling on a certain national road. In this case, to use the vehicle's location information as one of the various kinds of state information to be given to the input nodes of the probabilistic model, it is important to differentiate the case where the vehicle is traveling on that national road from the case where the vehicle is located in some other place than that national road. As shown in these two examples, the vehicle's location information differs not only in terms of the location but also in terms of the range it covers between the case where the vehicle is located in the parking lot of the park and the case where the vehicle is traveling on the national road; it is therefore clear that the vehicle's location information cannot be classified in advance according to such specific situations.

In view of the above, the clustering subunit 654 performs clustering on state information, such as the vehicle's current location, time, etc., whose value cannot be classified in advance, and determines the class of the value. For example, when the vehicle's current location is used as one of the input parameters to the probabilistic model to be generated, the clustering subunit 654 performs clustering on the operation points stored in the learned data Dₖ. For this purpose, the clustering subunit 654 refers to the distance reference table that stores the distances between the various operation points, and performs clustering on the operation points based on their distances by using a clustering technique such as a k-average method or a nearest neighbor method.

After the clustering is done, the clustering subunit 654 determines the class of each value of the state information based on the range of the data values of the state information that belong to each cluster. For example, when determining the class of the value of the vehicle's current location by performing clustering on the operation points stored in the learned data Dₖ, the clustering subunit 654 obtains for each cluster the centroid of the operation points that belong to that cluster. Further, the clustering subunit 654 obtains the distance l from the centroid to the operation point located farthest away in that cluster. Then, the clustering subunit 654 determines the class of the value of the vehicle's current location belonging to that cluster by defining an area centered at the centroid of the cluster and having a radius equal to the distance l. The clustering subunit 654 stores the thus obtained centroid and distance and the number of data contained in the cluster into the storage unit 61 by associating them with the cluster.

In relation to a plurality of standard models having predetermined graph structures, the probabilistic model constructing subunit 655 constructs tentative probabilistic models by generating CPTs for the nodes contained in the respective standard models based on the learned data and on the classes of the state information determined by the clustering subunit 654.

To construct a versatile probabilistic model that can address various situations, a very large probabilistic model containing a large number of nodes would have to be constructed. However, the learning of such a probabilistic model would require a very long computation time, and the hardware resources required for the learning would be enormous. Accordingly, in the present embodiment, data that are likely to have a particularly close relationship to the setting operation are selected from among the state information as parameters to be input to the input nodes, and 15 kinds of standard models are generated each having a two-layer graph structure in which the probability of the setting operation being performed is obtained based on the conditional probabilities for the combination of the input parameters. Here, the number of standard models is not limited to 15. The number of standard models can be optimized appropriately according to the number of kinds of state information obtained and to the kind of the setting operation to be learned. Each standard model may be constructed to take only one input parameter or to take all obtainable state information as input parameters. Further, the standard model is not limited to the two-layer graph structure, but may be constructed to have a graph structure of three or more layers, depending on the capability of the CPU constituting the control unit 60.

The standard models thus generated are stored in the storage unit 61. Then, the probabilistic model constructing subunit 655 constructs a tentative probabilistic model for each standard model by determining the CPT for each node contained in the standard model. That is, with the tentative probabilistic model, the probability of performing the setting operation associated with the tentative probabilistic model is determined based on the class of the value of the state information used as the input parameter.

A detailed description will be given below with reference to the drawings.

From the learned data Dₖ retrieved from the storage unit 61, the probabilistic model constructing subunit 655 counts for each node a corresponding number n for each class of the value of the state information. Then, the value obtained by dividing the number n by the total number of events, N, is taken as the value of the prior probability as well as the conditional probability. Here, if the class of the value of the state information used as the input parameter is already obtained by the clustering subunit 654, the probabilistic model constructing subunit 655 retrieves that class, i.e., the centroid and radius of each cluster, from the storage unit 61, and counts the number of pieces of state information according to that class. On the other hand, in the case of input parameters not clustered, the probabilistic model constructing subunit 655 counts the number of pieces of state information according to a predetermined class. In this way, by obtaining the prior probability and the conditional probability, the probabilistic model constructing subunit 655 determines the CPT for each node.

If it is considered that the number of data used for learning is not sufficient, the probabilistic model constructing subunit 655 may estimate the probability distribution using a beta distribution and use it to construct the CPT. If some of the combinations of the input information values do no exist in the learned data Dₖ, that is, if there is unobserved data, the probabilistic model constructing subunit 655 estimates the probability distribution of the unobserved data, and calculates the corresponding conditional probability by calculating the expected value based on the estimated distribution. For the learning of such conditional probabilities, use can be made, for example, of the method described in “Introduction to Bayesian Networks” by Kazuo Shigemasu et al., 1st Edition, Baifukan, July 2006, pp. 35-38, 85-87.

In a similar manner, the probabilistic model constructing subunit 655 generates for the output node a CPT that shows the distribution of the conditional probabilities based on the information given to the respective input nodes. In the initial state, the CPT is set so that the values are equal for all the states.

The probabilistic model evaluating subunit 656 selects the tentative probabilistic model having the most appropriate graph structure by applying an information criterion to all the tentative probabilistic models constructed by the probabilistic model constructing subunit 655.

In the present embodiment, AIC (Akaike's Information Criterion) is used as the information criterion. AIC can be obtained using the following equation based on the maximum logarithmic likelihood of the probabilistic model and the number of parameters.

AICₘ=−2lₘ(θₘ|X)+2kₘ

Here, AICₘ is the AIC for the probabilistic model M. Further, θₘ represents a set of parameters of the probabilistic model M, lₘ(θₘ|X) represents the value of the maximum logarithmic likelihood of given data X in the probabilistic model M, and kₘ represents the number of parameters of the probabilistic model M.

When AIC is obtained for all the probabilistic models, the probabilistic model evaluating subunit 656 selects the tentative probabilistic model that yielded the smallest AIC value.

For the selection of the probabilistic model (in other words, the learning of the graph structure), the probabilistic model evaluating subunit 656 may use other information criteria such as Bayes's Information Criterion (BIC), Takeuchi's Information Criterion (TIC), or Minimum Description Length (MDL).

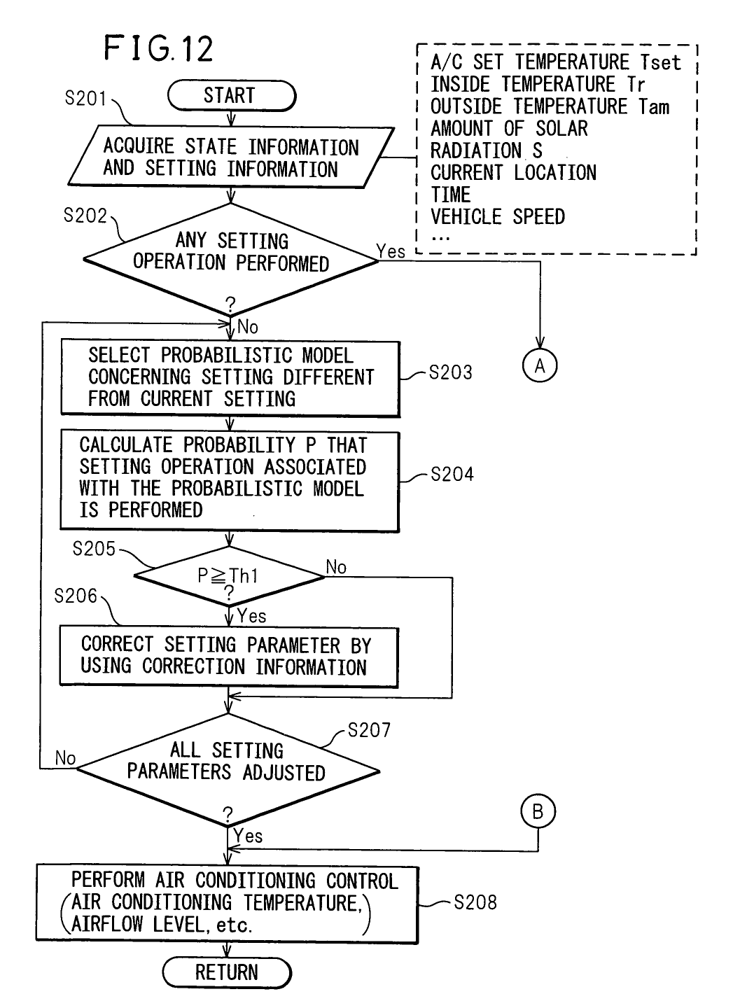

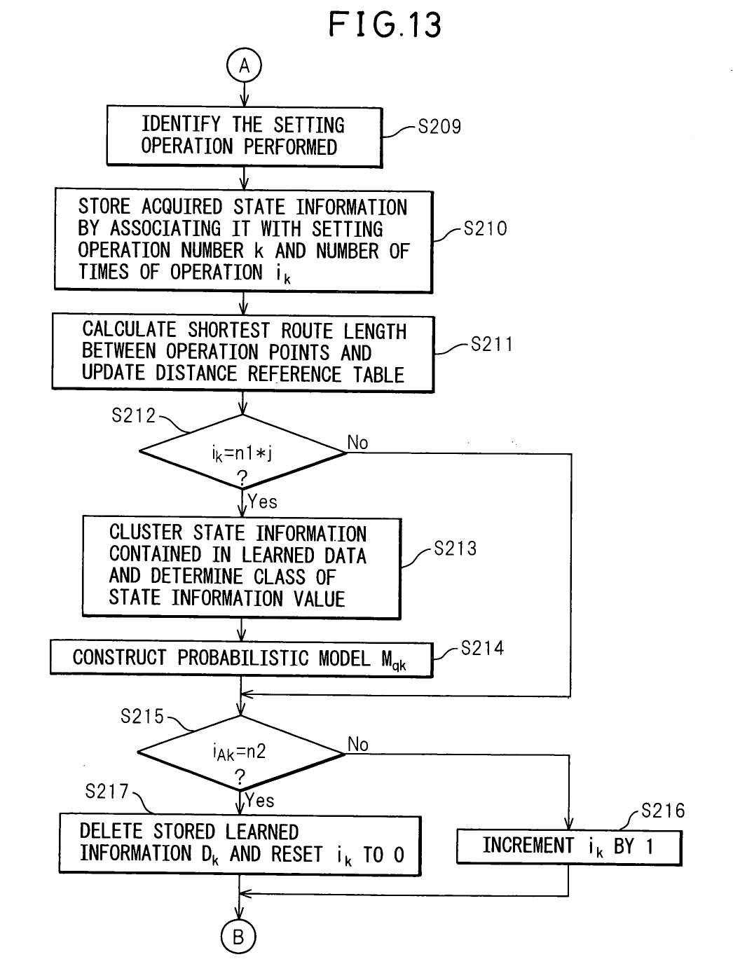

The operation of the air conditioning system 10 according to the second embodiment of the present invention will be described below with reference to the flowcharts shown in FIGS. 12 and 13. The air conditioning system 10 is controlled by the control unit 60 in accordance with a computer program incorporated in the control unit 60.

First, as shown in FIG. 12, when the engine switch is turned on, the control unit 60 starts the air conditioning system 10. Then, the control unit 60 acquires the state information from the sensor unit 30, the navigation apparatus 40, etc. via the communication unit 62 (step S201).

Next, the control unit 60 determines whether or not the occupant has performed any setting operation on the air conditioning system 10 (step S202). When an operation signal is received from the operation unit 50, the control unit 60 determines that a setting operation has been performed. If the occupant has not performed any setting operation, the control information correcting unit 63 in the control unit 60 selects a probabilistic model concerning the setting different from the current setting, from among the probabilistic models M_{qk} associated with the correction of the setting parameter (for example, the set temperature Tₛₑₜ) related to any one of the operation groups (step S203). Here, the probabilistic model M_{qk} represents the q-th probabilistic model constructed for the setting operation corresponding to the setting operation number k. Next, the control information correcting unit 63 enters the observed state information into the selected probabilistic model. The control information correcting unit 63 then calculates the probability that the setting operation associated with the probabilistic model is performed (step S204). Then, the control information correcting unit 63 obtains the highest probability P among the probabilities calculated for the setting operation in the same operation group associated with the setting parameter.

Next, the control information correcting unit 63 compares the probability P with the threshold value Th1 (step S205). If the probability P is greater than or equal to the threshold value Th1 (for example, 0.9), the control information correcting unit 63 corrects the corresponding setting parameter of the air conditioning system 10 based on the correction information associated with the probabilistic model that yielded the probability P (hereinafter called the selected probabilistic model) (step S206). On the other hand, if the probability P is smaller than the threshold value Th1, the control information correcting unit 63 does not correct the setting parameter.

After that, the control information correcting unit 63 determines whether all the setting parameters have been adjusted or not, by checking whether the probability has been calculated for all the probabilistic models that calculate the probability of the setting being changed from the current set value (step S207). If there is any probabilistic model for which the probability is not calculated yet, that is, if there is any operation group that is not yet checked as to whether the setting information is to be corrected or not, the control information correcting unit 63 returns control to step S203. On the other hand, if the probability has been calculated for all the probabilistic models, then the air-conditioning control unit 64 performs air conditioning control in accordance with the corrected setting parameters as required (step S208). More specifically, the air-conditioning control unit 64 adjusts the opening of the air mix door, the number of revolutions of the blower fan, and the opening of each air outlet door so as to achieve the desired air conditioning temperature, airflow level, etc.

As shown in FIG. 13, when the occupant has performed a setting operation on the air conditioning system in step S202, the control unit 60 identifies the kind of the setting operation by referring to the setting signal (step S209). Then, the learned information accumulating subunit 653 in the learning unit 65 stores the state information acquired at the time of the setting operation into the storage unit 61 as an element of the learned data Dₖ by associating it with the setting operation number k corresponding to the setting operation performed and the number of times, iₖ, that the setting operation has been performed (step S210). Then, the distance calculation subunit 652 in the learning unit 65 calculates, along the route the vehicle has traveled before, the shortest route length between the operation point contained in the state information and each operation point already stored as the learned data, and updates the distance reference table accordingly (step S211). Here, as previously described with reference to FIG. 3, when the current route and the past route, each having a finite length, overlap even partially, the distance calculation subunit 652 calculates the shortest route length between the operation point on the current route and the operation point on the past route along the current route or the past route. Alternatively, as previously described with reference to FIG. 4 or 5, the distance calculation subunit 652 may determine whether the current route and the past route overlap by referring only to the operation point on the past route or the current route or to the operation point and the starting point and end point of the past route.

Next, the learning unit 65 in the control unit 60 determines whether the number of times of the operation, iₖ, is equal to a predetermined number of times n1*j (j=1, 2, 3) (step S212). The predetermined number of times n1 is, for example, 10. If it is determined that iₖ=n1*j, the clustering subunit 654 in the learning unit 65 performs clustering on the state information that takes consecutive values, for example, the location information, in the learned data Dₖ stored in the storage unit 61 by being associated with the setting operation number k, and determines the class of its value (step S213).

After that, the learning unit 65 constructs the probabilistic model M_{qk} for that setting operation by using the learned data Dₖ thus clustered (step S214). More specifically, the probabilistic model constructing subunit 655 in the learning unit 65 constructs a tentative probabilistic model by generating CPTs for each standard model, as earlier described. Then, the probabilistic model evaluating subunit 656 in the learning unit 65 calculates the information criterion for each tentative probabilistic model, and the tentative probabilistic model that yielded the smallest information criterion value is selected as the probabilistic model M_{qk} to be used. The probabilistic model evaluating subunit 656 then stores the probabilistic model M_{qk} in the storage unit 61 by associating it with the setting operation number k, etc. On the other hand, if iₖ is not equal to n1*j in step S212, the learning unit 65 passes control to step S215.

Next, the learning unit 65 determines whether the number of times of the operation, iₖ, is equal to a predetermined number of times n2 (for example, n2=30) (step 215). If iₖ is not equal to n2, the learning unit 65 increments iₖ by 1 (step S216), and passes control to step S208. On the other hand, if iₖ=n2 in step S215, the learning unit 65 deletes the learned data Dₖ stored in the storage unit 61 by being associated with the occupant and the setting operation number k (step S217).

Further, it is determined that the probabilistic model M_{qk} currently stored in the storage unit 61 is an established one, and thereafter, no updating is performed on that probabilistic model M_{qk}. The learning unit 65 appends flag information to the established probabilistic model M_{qk} to indicate that the probabilistic model is not to be updated. For example, the learning unit 65 stores an update flag f in the storage unit 61 by associating it with the probabilistic model. The learning unit 65 can determine whether updating is allowed or not by checking the state of the flag; that is, if it is set to 1, updating (rewriting) is prohibited, and if it is set to 0, updating is allowed. The learning unit 65 initializes iₖ to 0. After that, the learning unit 65 passes control to step S208.

Here, the predetermined number of times n2 is a number larger than n1, and corresponds to the number of data considered sufficient to construct a statistically accurate probabilistic model. The predetermined numbers n1 and n2 can be optimized experimentally and empirically.

After that, the air conditioning system 10 repeats the control process from step S201 to step S217 at predetermined intervals of time or distance until its operation is stopped.

As described above, in generating the probabilistic model, the air conditioning system 10 according to the second embodiment of the present invention optimally determines the range of the state information values representing the vehicle state, air conditioning state, etc. corresponding to the specific situation and, based on the result, constructs the probabilistic model for calculating the probability; accordingly, the air conditioner setting can be automatically optimized so as to match the specific situation accurately. In particular, since the air conditioning system 10 calculates the distance between the operation points along the route that the vehicle has actually traveled, and determines the class of the vehicle location based on the calculated distance, the range of the points corresponding to any specific situation can be accurately determined.

The present invention is not limited to the above specific embodiment. For example, in the air conditioning system 10, the probabilistic model for calculating the probability of performing each specific setting operation may be generated for each preregistered user. In this case, the air conditioning system 10 stores the probabilistic model by associating it with the user's identification number. Further, the air conditioning system 10 is equipped with a special mechanism for identifying the occupant, and uses only the probabilistic model associated with the preregistered user identified by the mechanism as matching the occupant. Here, a device comprising a camera for capturing a face image of the occupant and a software module that runs on the control unit and that compares the face image of the occupant against the face images of the preregistered users for a match can be used as the mechanism for identifying the occupant.

Further, in the above embodiment, the parameters that the control information correcting unit 63 corrects based on probabilistic models are the setting parameters, such as the set temperature and airflow level, that the occupant can directly set from the operation unit 50. However, the control information correcting unit 63 may be configured to correct the control parameters directly related to the operation of the various parts of the air-conditioning unit 20, such as the air conditioning temperature Tₐₒ calculated using the temperature control equation, the number of revolutions of the blower fan calculated using the airflow level control equation, the opening of the air mix door, etc.

In the above embodiment, standard models having predefined graph structures have been generated in advance for the construction of probabilistic models. However, instead of generating such standard models, the learning unit 65 may be configured to search a graph structure by using a K2 algorithm or a genetic algorithm. For example, when using a genetic algorithm, a plurality of genes are generated each serving as an element indicating the presence or absence of a connection between nodes. Then, the learning unit 65 calculates the fitness of each gene by using the previously described information criterion. After that, the learning unit 65 selects genes having fitness values greater than a predetermined value, and performs such manipulations as crossover and mutation to produce the next generation of genes. The learning unit 65 repeats such manipulations a plurality of times and selects genes having the best fitness. The learning unit 65 uses the graph structure described by the selected genes to construct the probabilistic model. The learning unit 65 may combine any of these algorithms with the method of constructing the probabilistic model from a standard model.

The present invention can be applied not only to an air conditioning system but also to an apparatus that automatically performs some kind of processing when a specific point is approached. For example, the present invention can be applied to car audio equipment. For example, suppose that each time the vehicle approaches a point where an AM radio broadcast for traffic information can be received, the occupant performs an operation to tune the radio to the AM broadcast. In this case, the car audio equipment to which the present invention is applied calculates, in accordance with the present invention, the distance between each operation point where the tuning operation was performed along the route that the vehicle has traveled. Then, by clustering the operation points based on the distance between the operation points, the car audio equipment can accurately determine the range of the point where the tuning operation is to be performed. Then, a probabilistic model is generated that calculates the probability of tuning the radio to the AM broadcast based on the vehicle location information and, using this probabilistic model, the car audio equipment automatically tunes to the AM broadcast when the vehicle approaches a point where that AM broadcast can be received.

The present invention can also be used for controlling various parts of the vehicle, for example, the power windows, key locks, headlights, hazard lamps, door mirrors, fuel lid, sunroof, wipers, adaptive cruise control (ACC), adaptive variable suspensions (AVS), gear shifting, etc. For example, suppose that each time the vehicle approaches a tunnel, the occupant performs an operation to close the power windows. In this case, a vehicle-mounted apparatus for controlling the power windows calculates, in accordance with the present invention, the distance between each operation point where the operation to close the power windows was performed along the route that the vehicle has traveled. Then, by clustering the operation points based on the distance between the operation points, the vehicle-mounted apparatus can accurately determine the range of the point where the window closing operation is to be performed. Then, a probabilistic model is generated that calculates the probability of closing the power windows based on the vehicle location information. Using this probabilistic model, the vehicle-mounted apparatus automatically closes the power windows when the vehicle approaches a tunnel.

The present invention can also be applied to a portable telephone; in this case, if the user always performs a specific operation as the user approaches a specific place, the portable telephone can be made to automatically perform the specific operation when the user arrives at the specific place.

As described above, those skilled in the art can make various modifications within the scope of the present invention.

What is claimed is:

1. A route length calculation apparatus for calculating the shortest route length between a plurality of points of occurrence of events relating to a mobile object, said apparatus comprising:
a location detection unit for acquiring current location of said mobile object;
an event detection unit for detecting the occurrence of an applicable event;
a route history information storage unit for storing, upon occurrence of a first event, past route information containing at least the point of occurrence of said first event; and
a distance calculation unit for calculating, when occurrence of a second event is detected by said event detection unit, the shortest route length between the point of occurrence of said second event acquired by said location detection unit and the point of occurrence of said first event along a route that said mobile object has traveled before.

2. The route length calculation apparatus according to claim 1, wherein when the occurrence of said first event is detected, said route history information storage unit stores as said past route information a past route which is a route traveled by said mobile object when said mobile object passed the point of occurrence of said first event, and wherein
when it is determined that the point of occurrence of said second event is located on said past route, said distance calculation unit calculates said shortest route length along said past route.

3. The route length calculation apparatus according to claim 2, further comprising:
a road information acquiring unit for acquiring road information; and
a route determining unit for acquiring from said location detection unit the locations of a plurality of points on said past route within a predetermined range containing the point of occurrence of said first event, and for obtaining said past route information by matching the locations of said plurality of points with said road information acquired by said road information acquiring unit.

4. The route length calculation apparatus according to claim 2, wherein said past route information includes a first moving direction indicating the moving direction of said mobile object along said past route, and said location detection unit acquires a second moving direction indicating the moving direction of said mobile object at the point of occurrence of said second event, and wherein said distance calculation unit determines that the point of occurrence of said second event is located on said past route only when said second moving direction coincides with said first moving direction.

5. The route length calculation apparatus according to claim 2, wherein said past route information includes a traveled distance from a starting point to each of said plurality of points on said past route or a relative distance from the point of occurrence of said first event, and wherein
said distance calculation unit calculates said shortest route length by referring to said traveled distance or said relative distance.

6. The route length calculation apparatus according to claim 1, further comprising:
a road information acquiring unit for acquiring road information; and
a route determining unit for acquiring from said location detection unit the locations of a plurality of points on a current route which is a route traveled by said mobile object when said mobile object passed the point of occurrence of said second event when the occurrence of said second event is detected by said event detection unit, and for obtaining current route information indicating said current route by matching the locations of said plurality of points with said road information acquired by said road information acquiring unit, and wherein
when it is determined from said current road information, in conjunction with the point of occurrence of said first event stored in said route history information storage unit, that the point of occurrence of said first event is located on said current route, said distance calculation unit calculates said shortest route length along said current route.

7. The route length calculation apparatus according to claim 6, wherein said location detection unit acquires a moving direction of said mobile object at the time of detection of the location of said mobile object, and said past route information includes a first moving direction indicating the moving direction of said mobile object at the point of occurrence of said first event, while said current route information includes a second moving direction indicating the moving direction of said mobile object along said current route, and wherein said distance calculation unit determines that the point of occurrence of said first event is located on said current route only when said first moving direction coincides with said second moving direction.

8. The route length calculation apparatus according to claim 6, wherein said current route information includes a traveled distance from a starting point to each of said plurality of points on said current route or a relative distance from the point of occurrence of said second event, and wherein
said distance calculation unit calculates said shortest route length by referring to said traveled distance or said relative distance.

9. The route length calculation apparatus according to claim 1, further comprising:
a road information acquiring unit for acquiring road information; and
a route determining unit for acquiring from said location detection unit the locations of a plurality of points on a current route which is a route traveled by said mobile object when said mobile object passed the point of occurrence of said second event when the occurrence of said second event is detected by said event detection unit, and for obtaining current route information indicating said current route by matching the locations of said plurality of points with said road information acquired by said road information acquiring unit, and wherein
said route history information storage unit stores the point of occurrence of said first event as said past route information together with a specific point that said mobile object passed before or after passing the point of occurrence of said first event, and
when it is determined from said current road information, in conjunction with said past route information stored in said route history information storage unit, that said specific point is located on said current route, said distance calculation unit calculates said shortest route length along said current route or said past route.

10. The route length calculation apparatus according to claim 9, wherein said location detection unit acquires a moving direction of said mobile object at the time of detection of the location of said mobile object, and said past route information includes a first moving direction indicating the moving direction of said mobile object at said specific point, while said current route information includes a second moving direction indicating the moving direction of said mobile object along said current route, and wherein said distance calculation unit determines that said specific point is located on said current route only when said first moving direction coincides with said second moving direction.

11. The route length calculation apparatus according to claim 9, wherein said past route information includes a first traveled distance from a starting point to said specific point on said past route or a first relative distance from the point of occurrence of said first event, and said current route information includes a second traveled distance from a starting point to each of said plurality of points on said current route or a second relative distance from the point of occurrence of said second event, and wherein
said distance calculation unit calculates said shortest route length by referring to said first and second traveled distances or said first and second relative distances.

12. A route length calculation method for calculating the shortest route length between a plurality of points of occurrence of events relating to a mobile object, said method comprising:
detecting the occurrence of a first event;
storing, upon occurrence of said first event, past route information indicating a past route which is a route traveled by said mobile object when said mobile object passed the point of occurrence of said first event;
detecting the occurrence of a second event;
upon detecting the occurrence of said second event, acquiring the location of the point of occurrence of said second event; and
upon detecting the occurrence of said second event, calculating the shortest route length between the point of occurrence of said first event and the point of occurrence of said second event along said past route if it is determined from said past route information, in conjunction with the point of occurrence of said second event, that the point of occurrence of said second event is located on said past route.

13. A recording medium having a program recorded thereon for causing a computer to calculate the shortest route length between a plurality of points of occurrence of events relating to a mobile object, said program containing instructions for causing the computer to execute:
detecting the occurrence of a first event;
storing, upon occurrence of said first event, past route information indicating a past route which is a route traveled by said mobile object when said mobile object passed the point of occurrence of said first event;
detecting the occurrence of a second event;
upon detecting the occurrence of said second event, acquiring the location of the point of occurrence of said second event; and
upon detecting the occurrence of said second event, calculating the shortest route length between the point of occurrence of said first event and the point of occurrence of said second event along said past route if it is determined from said past route information, in conjunction with the point of occurrence of said second event, that the point of occurrence of said second event is located on said past route.

14. An automotive air conditioner comprising:
an air-conditioning unit for supplying conditioned air into a vehicle;
a location information acquiring unit for acquiring location information indicating the location of said vehicle;
a storage unit for storing past route information indicating a past route, which is a route traveled by said vehicle when said vehicle passed an operation point where a specific setting operation was performed by a vehicle occupant, and location information indicating the location of said operation point;
a learning unit for constructing a probabilistic model into which said location information is entered in order to calculate the probability of said occupant performing said specific setting operation;
a control information correcting unit for calculating said probability by entering said vehicle's current location information acquired by said location information acquiring unit into said probabilistic model constructed by said learning unit, and for correcting setting information or control information related to said occupant's setting operation in accordance with said probability so as to achieve said specific setting operation; and
an air-conditioning control unit for controlling said air-conditioning unit in accordance with said corrected setting information or control information, wherein
said learning unit includes:
a distance calculation subunit for constructing a distance reference table recording the shortest route length between operation points by calculating along said past route the shortest route length between a current operation point, which is acquired by said location information acquiring unit each time said specific setting operation is performed by said occupant, and a past operation point, at which said specific setting operation was performed on said past route, if it is determined from said acquired current operation point and said past route information stored in said storage unit that said current operation point is located on said past route;
a clustering subunit for classifying said operation points into at least a first cluster and a second cluster by referring to said distance reference table, and for determining a first range of vehicle location based on the operation points contained in said first cluster and a second range of vehicle location based on the operation points contained in said second cluster; and
a probabilistic model constructing subunit for constructing said probabilistic model associated with said specific setting operation by determining said probability for the vehicle location contained in said first range and said probability for the vehicle location contained in said second range.

15. A controller for an apparatus mounted in a mobile object, comprising:
a location information acquiring unit for acquiring location information indicating the location of said mobile object;
a storage unit for storing past route information indicating a past route, which is a route traveled by said mobile object when said mobile object passed an operation point where a specific setting operation relating to said apparatus was performed, and location information indicating the location of said operation point;
a learning unit for constructing a probabilistic model into which said location information is entered in order to calculate the probability of performing said specific setting operation on said apparatus;
a control information correcting unit for calculating said probability by entering said mobile object's current location information acquired by said location information acquiring unit into said probabilistic model constructed by said learning unit, and for correcting setting information or control information related to the setting operation of said apparatus in accordance with said probability so as to achieve said specific setting operation; and
a control unit for controlling said apparatus in accordance with said corrected setting information or control information, wherein
said learning unit includes:
a distance calculation subunit for constructing a distance reference table recording the shortest route length between operation points by calculating along said past route the shortest route length between a current operation point, which is acquired by said location information acquiring unit each time said specific setting operation is performed, and a past operation point, at which said specific setting operation was performed on said past route, if it is determined from said acquired current operation point and said past route information stored in said storage unit that said current operation point is located on said past route;
a clustering subunit for classifying said operation points into at least a first cluster and a second cluster by referring to said distance reference table, and for determining a first range of mobile object location based on the operation points contained in said first cluster and a second range of mobile object location based on the operation points contained in said second cluster; and
a probabilistic model constructing subunit for constructing said probabilistic model associated with said specific setting operation by determining said probability for the mobile object location contained in said first range and said probability for the mobile object location contained in said second range.
